(19) United States
(12) Patent Application Publication
(10) Pub. No.: US 2022/0239888 A1
(43) Pub. Date: Jul. 28, 2022

(54) VIDEO DISTRIBUTION SYSTEM, VIDEO DISTRIBUTION METHOD, AND DISPLAY TERMINAL

(71) Applicant: SONY GROUP CORPORATION, Tokyo (JP)

(72) Inventors: Hiroshi YAMAGUCHI, Tokyo (JP); Koji FURUSAWA, Kanagawa (JP)

(73) Assignee: SONY GROUP CORPORATION, Tokyo (JP)

(21) Appl. No.: 17/613,729

(22) PCT Filed: May 25, 2020
(86) PCT No.: PCT/JP2020/020580

§ 371 Date: Nov. 23, 2021

(30) Foreign Application Priority Data
Jun. 7, 2019 (JP) 2019-106978

(51) Int. Cl. H04N 13/239; H04N 13/246; H04N 13/122; H04N 13/332

(52) U.S. Cl. CPC H04N 13/239; H04N 13/246; H04N 2013/0074; H04N 13/332; H04N 13/122

(57) ABSTRACT

There is provided a video distribution system, a video distribution method, and a display terminal that enable more appropriate display of a video. The video distribution system includes an image acquisition unit that acquires a first image and a second image of a subject captured by a first camera and a second camera, a parameter adjustment unit that adjusts a parameter that affects an appearance to a user regarding a virtual subject corresponding to the subject in a virtual space represented by the first image and the second image that have been acquired, and a display control unit that displays a video representing the virtual space including the virtual subject corresponding to the adjusted parameter on a display terminal. The present technology can be applied to, for example, a system that distributes a stereoscopic video.

### TECHNICAL FIELD

The present technology relates to a video distribution system, a video distribution method, and a display terminal, and particularly relates to a video distribution system, a video distribution method, and a display terminal capable of more appropriately displaying a video.

### BACKGROUND ART

In recent years, for example, devices such as head mounted displays have been widely used as display terminals for viewing stereoscopic videos.

In this type of display terminal, a stereoscopic video is displayed on the basis of video information obtained by image-capturing a subject with a plurality of cameras, and an immersive image is provided to a user wearing the display terminal on the head.

Furthermore, as a technique for displaying a stereoscopic video, techniques disclosed in Patent Documents 1 and 2 are known.

### CITATION LIST

### Patent Document

Patent Document 1: Japanese Patent Application Laid-Open No. 2003-284093
Patent Document 2: Japanese Patent Application Laid-Open No. 2014-209768

### SUMMARY OF THE INVENTION

### Problems to be Solved by the Invention

Incidentally, when displaying the stereoscopic video on the display terminal, it is desirable to appropriately display a video required by the user who uses the display terminal.

The present technology has been made in view of such a situation, and is intended to more appropriately display a video.

### Solutions to Problems

A video distribution system according to one aspect of the present technology is a video distribution system including an image acquisition unit that acquires a first image and a second image of a subject captured by a first camera and a second camera, a parameter adjustment unit that adjusts a parameter that affects an appearance to a user regarding a virtual subject corresponding to the subject in a virtual space represented by the first image and the second image that have been acquired, and a display control unit that displays a video representing the virtual space including the virtual subject corresponding to the adjusted parameter on a display terminal.

A video distribution method according to one aspect of the present technology is a video distribution method including, by a video distribution system, acquiring a first image and a second image of a subject captured by a first camera and a second camera, adjusting a parameter that affects an appearance to a user regarding a virtual subject corresponding to the subject in a virtual space represented by the first image and the second image that have been acquired, and displaying a video representing the virtual space including the virtual subject corresponding to the adjusted parameter on a display terminal.

In the video distribution system and the video distribution method according to one aspect of the present technology, a first image and a second image of a subject captured by a first camera and a second camera is acquired, a parameter that affects an appearance to a user regarding a virtual subject corresponding to the subject in a virtual space represented by the first image and the second image that have been acquired is adjusted, and a video representing the virtual space including the virtual subject corresponding to the adjusted parameter is displayed on a display terminal.

A display terminal according to one aspect of the present technology is a display terminal including a display control unit that displays, on a display terminal, a video representing a virtual space including a virtual subject whose parameter is adjusted, the parameter affecting an appearance to a user regarding the virtual subject corresponding to a subject in the virtual space represented by a first image and a second image of the subject captured by a first camera and a second camera.

In the display terminal according to one aspect of the present technology, a video is displayed on a display terminal, the video representing a virtual space including a virtual subject whose parameter is adjusted, the parameter affecting an appearance to a user regarding the virtual subject corresponding to a subject in the virtual space represented by a first image and a second image of the subject captured by a first camera and a second camera.

### BRIEF DESCRIPTION OF DRAWINGS

FIG. 1 is a diagram illustrating an example of a configuration of an embodiment of a video distribution system.

FIG. 2 is a diagram illustrating an example of a configuration of a workstation.

FIG. 3 is a diagram illustrating an example of a configuration of a display terminal.

FIG. 4 is a diagram schematically illustrating a state where a user views a stereoscopic video.

FIG. 5 is a diagram schematically illustrating a state where a subject is image-captured by two cameras.

FIG. 6 is a diagram illustrating a camera inter-optical axis distance in a case where a subject is image-captured by two cameras.

FIG. 7 is a diagram illustrating a user's interpupillary distance in a case where the user views a stereoscopic video.

FIG. 8 is a diagram illustrating an example of a functional configuration of the video distribution system to which the present technology is applied.

FIG. 9 is a flowchart illustrating an overall processing flow of the video distribution system to which the present technology is applied.

FIG. 10 is a diagram schematically illustrating a state where a user views a stereoscopic video in a case where a relationship of IPD_CAM=IPD_USER occurs.

FIG. 11 is a diagram illustrating in detail a state where the user views the stereoscopic video in a case where the relationship of IPD_CAM=IPD_USER occurs.

FIG. 12 is a diagram schematically illustrating a state where the user views the stereoscopic video in a case where a relationship of IPD_CAM>IPD_USER occurs.

FIG. 13 is a diagram illustrating in detail a state where the user views the stereoscopic video in a case where the relationship of IPD_CAM>IPD_USER occurs.

FIG. 14 is a diagram illustrating in detail a state where the user views the stereoscopic video when IPD_CAM>IPD_USER in a case where a virtual subject is right in front.

FIG. 15 is a diagram illustrating in detail a state where the user views the stereoscopic video when IPD_CAM>IPD_USER in a case where the virtual subject is on a right front side.

FIG. 16 is a diagram illustrating a first example of a state where a first method is applied in a case where the relationship of IPD_CAM>IPD_USER occurs.

FIG. 17 is a diagram illustrating a second example of a state where the first method is applied in a case where the relationship of IPD_CAM>IPD_USER occurs.

FIG. 18 is a diagram illustrating a third example of a state where the first method is applied in a case where the relationship of IPD_CAM>IPD_USER occurs.

FIG. 19 is a diagram illustrating a fourth example of a state where the first method is applied in a case where the relationship of IPD_CAM>IPD_USER occurs.

FIG. 20 is a diagram schematically illustrating a distance to the virtual subject in a virtual space.

FIG. 21 is a diagram illustrating a state after conversion of the distance to the virtual subject in the virtual space.

FIG. 22 is a diagram illustrating a first example of a state where a second method is applied in a case where the relationship of IPD_CAM>IPD_USER occurs.

FIG. 23 is a diagram illustrating a second example of a state where the second method is applied in a case where the relationship of IPD_CAM>IPD_USER occurs.

FIG. 24 is a diagram illustrating a third example of a state where the second method is applied in a case where the relationship of IPD_CAM>IPD_USER occurs.

FIG. 25 is a diagram illustrating a state where videos to be attached to entire celestial spheres are rotated outward when IPD_CAM>IPD_USER in a case where the virtual subject is right in front.

FIG. 26 is a diagram illustrating a state where the videos to be attached to the entire celestial spheres are rotated inward when IPD_CAM>IPD_USER in a case where the virtual subject is right in front.

FIG. 27 is a diagram illustrating a first example of a state where a third method is applied in a case where the relationship of IPD_CAM>IPD_USER occurs.

FIG. 28 is a diagram illustrating a second example of a state where the third method is applied in a case where the relationship of IPD_CAM>IPD_USER occurs.

FIG. 29 is a diagram illustrating a third example of a state where the third method is applied in a case where the relationship of IPD_CAM>IPD_USER occurs.

FIG. 30 is a diagram illustrating a state where the entire celestial spheres to which the videos are attached are moved outward when IPD_CAM>IPD_USER in a case where the virtual subject is right in front.

FIG. 31 is a diagram illustrating a state where the entire celestial spheres to which the videos are attached are moved inward when IPD_CAM>IPD_USER in a case where the virtual subject is right in front.

FIG. 32 is a diagram illustrating an example when an appearance of a video is changed in time series.

FIG. 33 is a diagram illustrating a configuration example of a computer.

### MODE FOR CARRYING OUT THE INVENTION

Hereinafter, embodiments of the present technology will be described with reference to the drawings. Note that the description will be made in the following order.

1. Embodiments of present technology

2. Modification example

3. Configuration of computer

<1. Embodiments of Present Technology>

(Configuration of Video Distribution System)

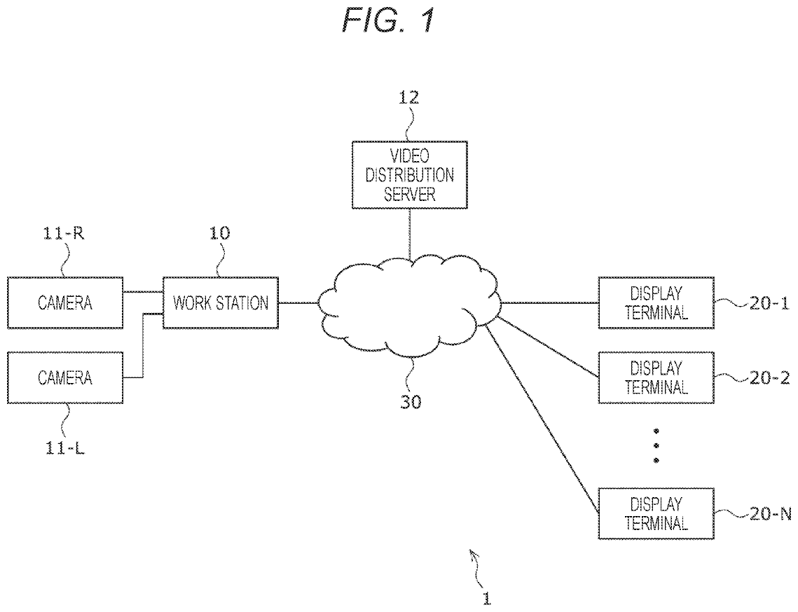

FIG. 1 illustrates an example of a configuration of a video distribution system.

In FIG. 1, a video distribution system 1 includes a workstation 10, a camera 11-R, a camera 11-L, a video distribution server 12, and display terminals 20-1 to 20-N (N: an integer of 1 or more). Furthermore, in the video distribution system 1, the workstation 10, the video distribution server 12, and the display terminals 20-1 to 20-N are connected to the Internet 30.

The workstation 10 is an image processing device specialized in image processing. The workstation 10 performs image processing on a plurality of images captured by the cameras 11-L and 11-R, and transmits data obtained by the image processing to the video distribution server 12 via the Internet 30.

The camera 11-L and the camera 11-R are configured as stereo cameras, and for example, when a subject is viewed from a front, the camera 11-L is installed at a position on the left side with respect to the subject, and the camera 11-R is installed at a position on the right side with respect to the subject.

The camera 11-L includes, for example, an image sensor such as a complementary metal oxide semiconductor (CMOS) image sensor or a charge coupled device (CCD) image sensor, and a signal processing unit such as a camera image signal processor (ISP). The camera 11-L transmits data of a captured image (hereinafter, also referred to as a left image) to the workstation 10.

Similarly to the camera 11-L, the camera 11-R includes an image sensor and a signal processing unit, and transmits data of a captured image (hereinafter, also referred to as a right image) to the workstation 10.

Note that the camera 11-L and the camera 11-R may be connected to the workstation 10 via a communication line such as a dedicated line (cable), for example, or may be connected by wired communication or wireless communication conforming to a predetermined standard. Furthermore, in the following description, the camera 11-L and the camera 11-R are simply referred to as the camera 11 in a case where it is not particularly necessary to distinguish them.

The video distribution server 12 is, for example, a web server installed in a data center or the like. The video distribution server 12 receives data transmitted from the workstation 10. In a case where video distribution is requested from any of the display terminals 20-1 to 20-N, the video distribution server 12 transmits a video stream including data from the workstation 10 to the display terminal 20 that is a request source of the video distribution via the Internet 30.

The display terminal 20-1 is configured as a head mounted display that is worn on the head so as to cover both eyes of the user and allows viewing a moving image or a still image displayed on a display screen provided in front of the eyes of the user. Note that the display terminal 20-1 is not limited to a head mounted display, and may be an electronic device having a display such as a smartphone, a tablet terminal, or a game machine.

The display terminal 20-1 transmits a request for video distribution to the video distribution server 12 via the Internet 30, for example, according to an operation of the user. The display terminal 20-1 receives and processes a video stream transmitted from the video distribution server 12 via the Internet 30, and reproduces a video. The video includes a moving image such as a virtual reality (VR) moving image distributed (real-time distribution (live distribution) or on-demand distribution) from the video distribution server 12, and content such as a still image.

Similarly to the display terminal 20-1, the display terminals 20-2 to 20-N include, for example, a head mounted display and the like, and each reproduce videos (for example, moving images, still images, and the like) distributed as video streams from the video distribution server 12. Note that, in the following description, the display terminals 20-1 to 20-N are simply referred to as the display terminal 20 in a case where it is not particularly necessary to distinguish them.

(Configuration of Workstation)

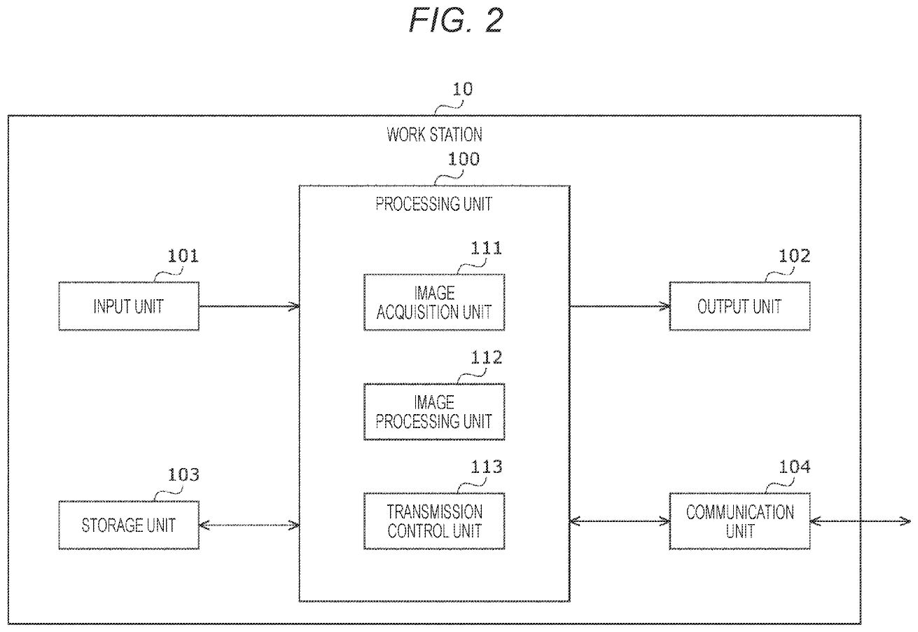

FIG. 2 illustrates an example of a configuration of the workstation 10 of FIG. 1.

In FIG. 2, the workstation 10 includes a processing unit 100, an input unit 101, an output unit 102, a storage unit 103, and a communication unit 104.

The processing unit 100 includes a processor such as a central processing unit (CPU), a graphic card (video card), and the like. The processing unit 100 is a main processing device that controls operation of each unit and performs various types of arithmetic processing.

The input unit 101 includes a keyboard, a mouse, physical buttons, and the like. The input unit 101 supplies an operation signal corresponding to an operation of the user to the processing unit 100.

The output unit 102 includes a display, a speaker, and the like. The output unit 102 outputs video, audio, and the like under control of the processing unit 100.

The storage unit 103 includes a semiconductor memory including a nonvolatile memory or a volatile memory, a buffer memory, and the like. The storage unit 103 stores various data under the control of the processing unit 100.

The communication unit 104 includes a communication module compatible with wireless communication or wired communication conforming to the predetermined standard, a video or audio capture card, and the like.

The communication unit 104 exchanges various data with the video distribution server 12 via the Internet 30 under the control of the processing unit 100. Furthermore, the communication unit 104 receives data from the camera 11-L and the camera 11-R under the control of the processing unit 100.

Furthermore, the processing unit 100 includes an image acquisition unit 111, an image processing unit 112, and a transmission control unit 113.

The image acquisition unit 111 acquires (captures) respective image signals of the left image captured by the camera 11-L and the right image captured by the camera 11-R via the communication unit 104, and stores the image signals in the storage unit 103.

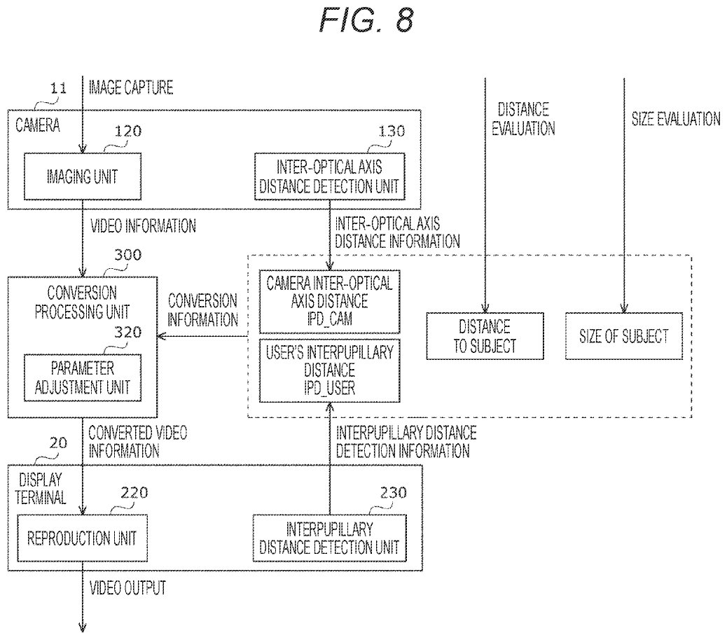

The image processing unit 112 reads image signals of the left image and the right image stored in the storage unit 103, performs predetermined image processing, and supplies data obtained as a result of the image processing to the transmission control unit 113. Note that although details will be described later with reference to FIG. 8 and the like, this image processing includes processing such as conversion processing for video information including image signals of the left image and the right image.

The transmission control unit 113 controls the communication unit 104 to transmit the data from the image processing unit 112 to the video distribution server 12 via the Internet 30.

(Configuration of Display Terminal)

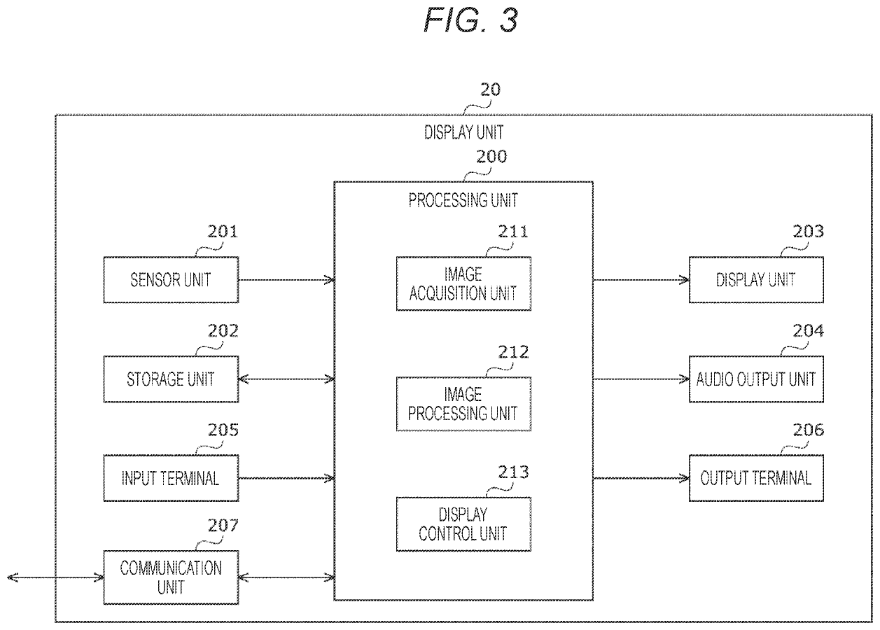

FIG. 3 illustrates an example of a configuration of the display terminal 20 in FIG. 1.

In FIG. 3, the display terminal 20 includes a processing unit 200, a sensor unit 201, a storage unit 202, a display unit 203, an audio output unit 204, an input terminal 205, an output terminal 206, and a communication unit 207.

The processing unit 200 includes a CPU and the like. The processing unit 200 is a main processing device that controls the operation of each unit and performs various types of arithmetic processing. Note that, here, a dedicated processor such as a graphics processing unit (GPU) may be provided.

The sensor unit 201 includes various sensor devices and the like. The sensor unit 201 performs sensing of the user, the surroundings thereof, and the like, and supplies sensor data corresponding to sensing results to the processing unit 200.

Here, the sensor unit 201 can include a magnetic sensor that detects the magnitude and direction of a magnetic field, an acceleration sensor that detects acceleration, a gyro sensor that detects an angle (posture), an angular velocity, and an angular acceleration, a proximity sensor that detects a nearby object, and the like. Furthermore, a camera having an image sensor may be provided as the sensor unit 201, and an image signal obtained by image-capturing a subject may be supplied to the processing unit 200.

The storage unit 202 includes a semiconductor memory or the like including a nonvolatile memory or a volatile memory. The storage unit 202 stores various data under the control of the processing unit 200.

The display unit 203 includes a display device (display apparatus) such as a liquid crystal display (LCD) or an organic light-emitting diode (OLED) display. The display unit 203 displays a video (a moving image, a still image, or the like) corresponding to the video data supplied from the processing unit 200.

The audio output unit 204 includes an audio output device such as a speaker. The audio output unit 204 outputs audio (sound) corresponding to audio data supplied from the processing unit 200.

The input terminal 205 includes an input interface circuit and the like, and is connected to an electronic device via a predetermined cable. The input terminal 205 supplies, for example, an image signal, an audio signal, a command, and the like input from a device such as a game machine (dedicated console), a personal computer, or a reproduction machine to the processing unit 200.

The output terminal 206 includes an output interface circuit and the like, and is connected to an electronic device via a predetermined cable. The output terminal 206 outputs an audio signal supplied thereto to a device such as an earphone or a headphone via a cable.

The communication unit 207 is configured as a communication module compatible with wireless communication such as wireless local area network (LAN), cellular communication (for example, LTE-Advanced, 5G, or the like), or Bluetooth (registered trademark), or wired communication.

The communication unit 207 exchanges various data with the video distribution server 12 via the Internet 30 under the control of the processing unit 200. Furthermore, the communication unit 207 can communicate with an external device including a game machine (dedicated console), a personal computer, a server, a reproduction machine, a dedicated controller, a remote controller, and the like.

Furthermore, the processing unit 200 includes an image acquisition unit 211, an image processing unit 212, and a display control unit 213.

The image acquisition unit 211 acquires data included in the video stream distributed from the video distribution server 12, and stores the data in the storage unit 202.

The image processing unit 212 reads data stored in the storage unit 202, performs predetermined image processing, and supplies data obtained as a result of the image processing to the display control unit 213. Note that this image processing can include processing such as conversion processing for video information in addition to processing such as decoding.

The display control unit 213 displays a video such as a moving image or a still image on the display unit 203 on the basis of the data from the image processing unit 212.

The video distribution system 1 is configured as described above.

(Conventional Problem)

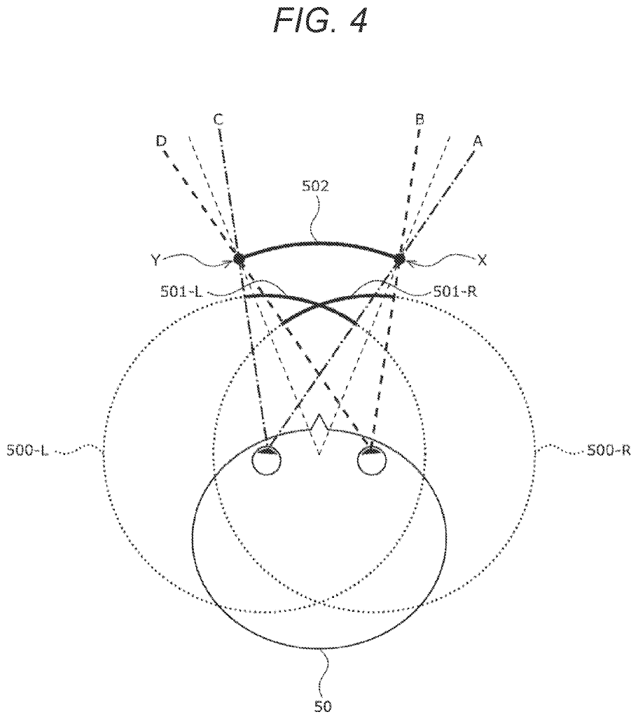

Next, problems of the prior art will be described with reference to FIGS. 4 to 7.

In the video distribution system 1, in order to view a stereoscopic video, a subject is image-captured by the cameras 11-L and 11-R configured as stereo cameras, and video is displayed on the immersive display terminal 20 using video information including a left image and a right image obtained by the image-capturing.

Here, in the conventional non-immersive display terminal (for example, a display apparatus such as a television receiver), regarding perception of the size of the subject, in addition to the size of the subject displayed on the display terminal and the optical size obtained from the distance between the viewing user and the display terminal, an image-captured environment, zoom level, and the like are flexibly adjusted by each individual in consideration of each experience.

This is based on the recognition that the display surface of the display terminal and the environment to which the user belongs are not continuous and different, and even if the optical size (viewing angle) of the subject changes due to the display terminal, the distance to the display terminal, and other conditions, this does not directly affect the perception of the size of the subject.

On the other hand, in the immersive display terminal 20, since the display surface and the environment to which the user belongs are felt to be continuous, when the optical size (viewing angle) changes, it is evaluated that the size of the subject itself has changed.

In the present technology, an expression as illustrated in FIG. 4 is used to conceptually indicate the viewing angle described above. That is, FIG. 4 schematically illustrates a state where a user 50 views the stereoscopic video using the immersive display terminal 20 when seen from above.

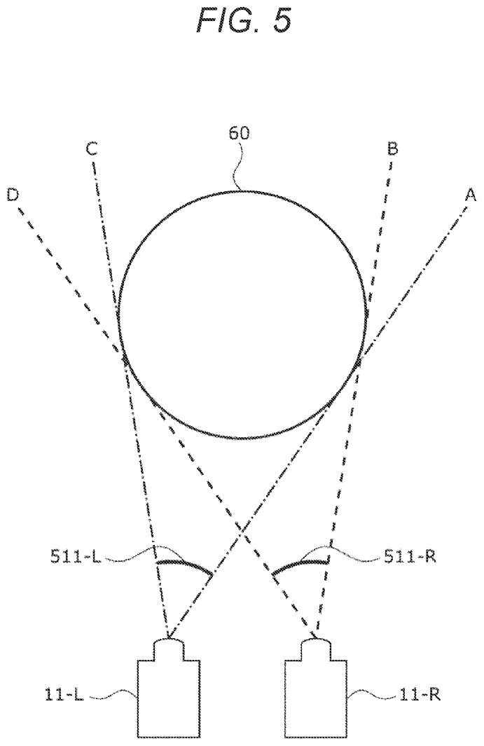

Furthermore, FIG. 5 schematically illustrates a state where a subject 60 is image-captured by the two cameras 11-L and 11-R when seen from above.

Here, in a case where the user 50 views a stereoscopic image using the display terminal 20 such as a head mounted display, it is common that the user 50 views videos (videos corresponding to a left image and a right image) respectively captured by the camera 11-L and the camera 11-R, such as a video 500-L for the left eye and a video 500-R for the right eye.

That is, when the subject 60 is viewed from the front, the video 500-L corresponds to the left image captured by the camera 11-L installed at the position on the left side of the image-capturing environment, and the video 500-R corresponds to the right image captured by the camera 11-R installed at the position on the right side of the image-capturing environment.

Here, a drawing range 501-L in FIG. 4 indicates a drawing range of the subject 60 with respect to the left eye, and corresponds to an imaging range 511-L of the subject 60 captured by the camera 11-L in FIG. 5. Furthermore, a drawing range 501-R in FIG. 4 indicates a drawing range of the subject 60 with respect to the right eye, and corresponds to an imaging range 511-R of the subject 60 captured by the camera 11-R in FIG. 5.

That is, in a case where the user 50 views the subject 60 (that is, a virtual subject) displayed as the stereoscopic video using the immersive display terminal 20, the user views the subject within the range including the drawing range 501-L from the left eye and the drawing range 501-R from the right eye.

At this time, in FIG. 4, a point at which a straight line A connecting a right end of the drawing range 501-L and the center of the left eye of the user 50 intersects a straight line B connecting a right end of the drawing range 501-R and the center of the right eye of the user 50 is defined as an intersection X. Furthermore, in FIG. 4, a point at which a straight line C connecting a left end of the drawing range 501-L and the center of the left eye of the user 50 intersects a straight line D connecting a left end of the drawing range 501-R and the center of the right eye of the user 50 is defined as an intersection Y.

Here, since the intersection X and the intersection Y are points on a straight line connecting the left and right eyes of the user 50 and ends of a portion where (the video of) the virtual subject is projected on projection surface, the intersections X and Y can be regarded as left and right ends of the virtual subject when stereoscopic viewing is performed. Thus, the size of the virtual subject (virtual object) perceived by the user 50 in the virtual space can be expressed as a viewing angle 502.

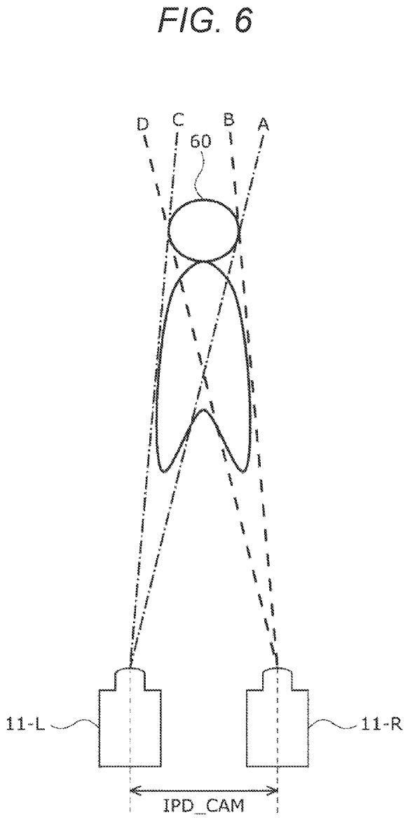

FIG. 6 illustrates a distance between the optical axis of the optical system of the camera 11-L and the optical axis of the optical system of the camera 11-R (hereinafter, will be referred to as “camera inter-optical axis distance IPD_CAM”) in a case where the subject 60 is image-captured by the two cameras 11-L and 11-R.

In FIG. 6, the subject 60 is image-captured by the camera 11-L and the camera 11-R installed at an interval corresponding to the camera inter-optical axis distance IPD_CAM. At this time, there is a case where the camera inter-optical axis distance IPD_CAM cannot be freely determined due to, for example, the sizes of the camera 11 and the lens, other physical limitations, restrictions on the image-capturing environment, and the like.

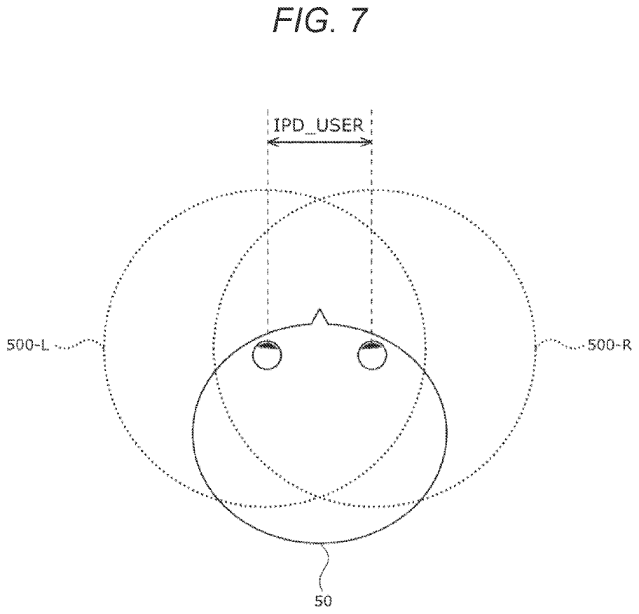

FIG. 7 illustrates a distance (hereinafter, referred to as a user's interpupillary distance IPD_USER) between pupils of left and right eyes of the user 50 in a case where the user 50 wearing the display terminal 20 such as a head mounted display views a stereoscopic video.

Here, in order to perform stereoscopic viewing, it is necessary to arrange the video 500-L and a video 500-R corresponding to the left image and the right image respectively captured by the camera 11-L and the camera 11-R on the virtual space in accordance with the user's interpupillary distance IPD_USER.

In a normal implementation, the video 500-L and the video 500-R corresponding to the captured left image and right image are projected (attached) on an entire celestial sphere for the left eye and an entire celestial sphere for the right eye, respectively, and virtual cameras (virtual cameras corresponding to positions of the left eye and the right eye of the user) are installed at centers of the respective entire celestial spheres, so that the user 50 can view (observe) the videos from the centers of the respective entire celestial spheres at the viewing position.

Note that, in the normal implementation, in a case where the user 50 wearing the display terminal 20 moves the head back and forth, left and right, and up and down, the entire celestial sphere is implemented to accompany the movement in a similar manner, and thus an appearance of the stereoscopic video from the user 50 does not change.

Furthermore, in a case where the user 50 rotates the head in the yaw direction or the roll direction (rotation other than vertical rotation, that is, rotation in which the positions of the eyes of the user 50 are shifted from the centers of the entire celestial spheres), parallax deviation occurs, and thus the user 50 cannot correctly view the stereoscopic video. However, as long as the user 50 does not move the eye positions, that is, only moves the eyeballs, the stereoscopic video can be viewed correctly.

At this time, if the user's interpupillary distance IPD_USER and the camera inter-optical axis distance IPD_CAM coincide, the display terminal 20 can reproduce the environment at the time of image-capturing including the appearance to the user such as a sense of size (size) and a sense of distance of the virtual subject.

However, due to restrictions on the sizes of a lens and a camera body in the camera 11, the value of the camera inter-optical axis distance IPD_CAM cannot be made equal to or less than a certain value, and a relationship of IPD_CAM>IPD_USER is inevitable in some cases.

Note that, in recent years, since downsizing of cameras has progressed, it is possible to select a system in which the value of the camera inter-optical axis distance IPD_CAM can be set to be small, but there are various demands for image-capturing environment, video quality, and usability, and such a system cannot be necessarily selected in all cases.

Furthermore, conversely, it is also assumed that the camera needs to have a certain size or less depending on the environment in which the subject 60 is image-captured, and in this case, the relationship of IPD_CAM<IPD_USER may inevitably occur.

If it is assumed to correspond to various image-capturing targets and image-capturing environments in this manner, it is practically difficult to always make the user's interpupillary distance IPD_USER and the camera inter-optical axis distance IPD_CAM coincide.

Furthermore, as illustrated in FIG. 7, since the user's interpupillary distance IPD_USER is generally different for each user, it is difficult to uniquely determine the optimum user's interpupillary distance IPD_USER to be set at the time of image-capturing. Thus, in order to unify the appearance between individual users, it is necessary to finally perform some adjustment regardless of the image-capturing environment.

Accordingly, the present technology enables to more appropriately display a video by adjusting a difference in appearance of the stereoscopic video caused due to the difficulty in making the user's interpupillary distance IPD_USER and the camera inter-optical axis distance IPD_CAM coincide and the presence of variation in the user's interpupillary distance IPD_USER.

Note that in the following description, an example of adjusting a parameter correlated with the relationship between the camera inter-optical axis distance IPD_CAM and the user's interpupillary distance IPD_USER will be mainly described, and the parameter is an example of a parameter that affects the appearance to the user such as a sense of size and a sense of distance of the virtual subject.

(Functional Configuration of Video Distribution System)

FIG. 8 illustrates an example of a functional configuration of the video distribution system 1 of FIG. 1.

In FIG. 8, the video distribution system 1 includes the camera 11 including an imaging unit 120 and an inter-optical axis distance detection unit 130, the display terminal 20 including a reproduction unit 220 and an interpupillary distance detection unit 230, and a conversion processing unit 300.

The conversion processing unit 300 is included in (the processing unit 100 of) the workstation 10 or (the processing unit 200 of) the display terminal 20, for example. However, the conversion processing unit 300 is not limited to the workstation 10 and the display terminal 20, and may be included in another device such as the camera 11.

Note that, in the configuration of FIG. 8, only one camera 11 is illustrated for simplification of description, but in practice, two cameras 11-L and 11-R configured as stereo cameras are installed for a subject.

In the camera 11, the imaging unit 120 image-captures the subject and outputs (transmits) video information obtained by the image-capturing to the conversion processing unit 300.

Furthermore, the inter-optical axis distance detection unit 130 detects the camera inter-optical axis distance IPD_CAM and outputs a detection result thereof as inter-optical axis distance information.

Here, the camera inter-optical axis distance IPD_CAM can be detected using a sensor or the like, or can be manually measured or given as a fixed value.

Thus, the inter-optical axis distance detection unit 130 is not necessarily included in the camera 11, but the camera inter-optical axis distance IPD_CAM is uniquely determined by the installation position of the camera 11-L and the installation position of the camera 11-R, and even in a case where the inter-optical axis distance detection unit 130 is not included, the essential configuration of the present technology does not change.

In the display terminal 20, the interpupillary distance detection unit 230 detects the user's interpupillary distance IPD_USER and outputs a detection result as interpupillary distance information.

Here, the user's interpupillary distance IPD_USER is detected by, for example, using a detection result by the sensor unit 201 (FIG. 3) or analyzing a captured image at a predetermined timing before the user wearing the display terminal 20 on the head performs an operation of starting reproduction of a video or during reproduction of a video.

The inter-optical axis distance information (camera inter-optical axis distance IPD_CAM) and the interpupillary distance information (user's interpupillary distance IPD_USER) are input to the conversion processing unit 300 as conversion information.

However, the conversion information is not limited to the inter-optical axis distance information and the interpupillary distance information, and can include, for example, information regarding a distance to a virtual subject (main virtual subject among one or a plurality of virtual subjects) and information regarding the size of a virtual subject (main virtual subject among one or a plurality of virtual subjects).

Then, the conversion processing unit 300 performs conversion processing on the video information from the camera 11 on the basis of the conversion information input thereto, and outputs (transmits) converted video information obtained as a result to the display terminal 20.

More specifically, the conversion processing unit 300 uses the video information and the conversion information to perform conversion processing according to, for example, any one of the first to third methods or a combination of at least two of the first to third methods.

In this conversion processing, in order to perform appropriate conversion (correction), it is necessary to appropriately adjust parameters (parameters that affect the appearance to the user regarding the virtual subject) according to each method. In the conversion processing unit 300, a parameter adjustment unit 320 is provided to adjust this parameter. Note that details of the three methods of the first method to the third method will be described later.

In the display terminal 20, on the basis of the converted video information input thereto, the reproduction unit 220 reproduces video after conversion (stereoscopic video), and displays the video on the display unit 203. Consequently, the user wearing the display terminal 20 on the head can view the stereoscopic video displayed in front of the eyes.

(Overall Processing Flow)

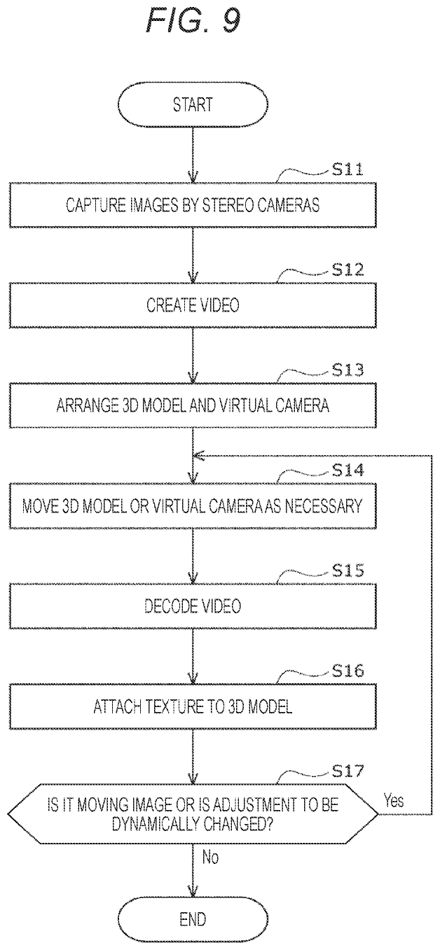

Next, an overall processing flow of the video distribution system 1 of FIG. 1 will be described with reference to a flowchart of FIG. 9.

In step S11, the subject is image-captured by the two cameras 11-L and 11-R configured as stereo cameras.

In step S12, for example, post-production processing is performed by a distribution side such as a content creator, and a video for distribution is created by (the processing unit 100 of) the workstation 10.

In this post-production processing, as processing after image-capturing, for example, each of a video corresponding to the entire celestial sphere for the left eye of the user based on the left image captured by the camera 11-L and a video corresponding to the entire celestial sphere for the right eye of the user based on the right image captured by the camera 11-R is generated.

The video for distribution created here is distributed as a video stream by the video distribution server 12 to the display terminal 20 via the Internet 30.

In steps S13 to S16, (the processing unit 200 of) the display terminal 20 processes the video stream received via the Internet 30, and performs decoding and rendering processing, for example.

Specifically, in the display terminal 20, a 3D model and a virtual camera are arranged in the entire celestial spheres for the left eye and the right eye (S13), and processing of moving the arranged 3D model or virtual camera is performed as necessary (S14).

That is, here, in the virtual space, the virtual camera corresponding to the left eye of the user is arranged at the center of the entire celestial sphere for the left eye, and the virtual camera corresponding to the right eye of the user is arranged at the center of the entire celestial sphere for the right eye (S13). Furthermore, in the virtual space, a 3D model including a virtual subject corresponding to the subject that is image-captured by the stereo cameras is arranged (S13).

Furthermore, in this example, since the conversion processing unit 300 (FIG. 8) is included in (the processing unit 200 of) the display terminal 20, in a case where the relationship of IPD_CAM>IPD_USER occurs, or the like, the arranged 3D model or virtual camera is moved by performing the conversion processing according to any one of the first method to the third method or a combination of at least two methods of the first method to the third method (S14).

Subsequently, the display terminal 20 decodes the video (S15), and performs processing of attaching a texture to the 3D model (S16).

Thus, for example, texture is given to the surface of the 3D model including the virtual subject (S16). Note that, at this time, the conversion processing unit 300 (FIG. 8) rotates and attaches the texture to the 3D model, for example, so that it is possible to support the second method to be described later (that is, although details will be described later, the video to be attached to the entire celestial sphere can be rotated).

In step S17, it is determined whether the video to be reproduced is a moving image or the adjustment of the parameter is to be dynamically changed.

In a case where it is determined as affirmative (“Yes”) in the determination processing of step S17, the processing returns to step S14, and the processing of step S14 and subsequent steps is repeated. On the other hand, in a case where it is determined as negative (“No”) in the determination processing of step S17, the processing ends.

For example, in a case where there is a change in the subject as an image-capturing target, and there is implementation of dynamically adjusting the parameter according to an amount of the change, affirmative determination (“Yes”) is made in the determination processing of step 317, the processing of steps S14 to S16 is repeated, and the conversion processing by the conversion processing unit 300 is performed in the processing of step S14 or S16. Furthermore, the display terminal 20 may (temporarily) store the data of the video subjected to the conversion processing in the storage unit 202. Thus, the user can view the video subjected to the conversion processing later.

Note that, in the above description, although a case where the parameter adjustment according to the three methods of the first method to the third method is performed at a time of the rendering processing (S14, 316) has been described, the parameter adjustment may be performed not only at the time of the rendering processing but also, for example, at a time of the post-production processing (S12). That is, in this case, the conversion processing unit 300 is included not in (the processing unit 200 of) the display terminal 20 but in (the processing unit 100 of) the workstation 10.

However, as described with reference to FIG. 9, if it is handled at the time of rendering processing, it is possible to distribute a common video as a video stream from the distribution side and meanwhile display a video unique to each user viewing on the display terminal 20 side (video subjected to conversion processing), and thus there is an advantage that the degree of freedom at the time of distributing the video is increased.

Furthermore, in FIG. 9, what is distributed as a video stream is not limited to a moving image and may be a still image, and for example, in a case where the display terminal 20 side processes a still image as a video, it is determined as negative (“No”) in the determination processing of step S17 and the processing (loop) of steps S14 to S16 is not repeated, except for a case where parameter adjustment is dynamically performed.

The overall processing flow of the video distribution system 1 has been described above.

(Principle of Present Technology)

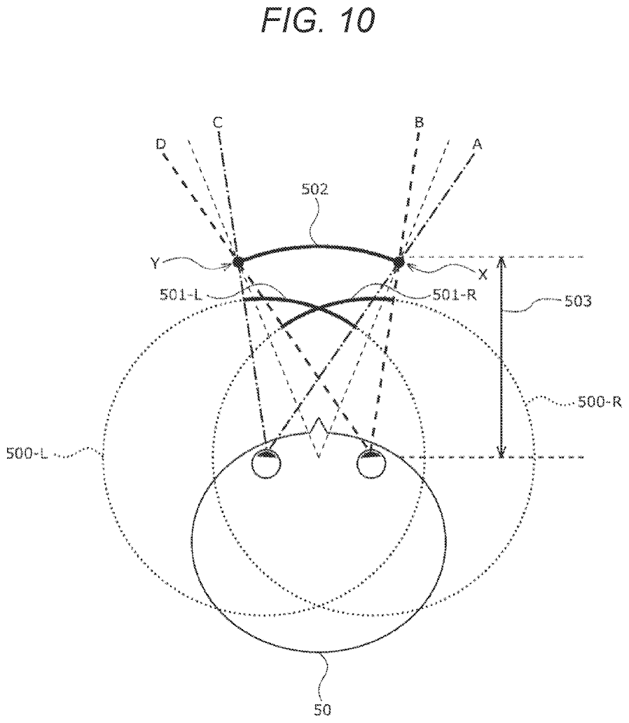

Here, the principle of the present technology will be described with reference to FIGS. 10 to 15.

FIG. 10 schematically illustrates a state where the user 50 wearing the display terminal 20 views the stereoscopic video, when seen from above, in a case where the video 500-L and the video 500-R corresponding to the left image and the right image respectively captured by the camera 11-L and the camera 11-R installed at the positions corresponding to the camera inter-optical axis distance IPD_CAM with respect to the subject are arranged in the virtual space. However, FIG. 10 illustrates when a relationship of IPD_CAM=IPD_USER occurs.

Note that, in FIG. 10, a direction from a lower side to an upper side in the diagram is a forward direction. Furthermore, this relationship similarly applies to other corresponding drawings.

As illustrated in FIG. 10, as a representative value characterizing an appearance of a virtual subject (virtual object), in addition to the viewing angle 502, a fusion distance 503 and the like can be exemplified, and an appearance of the virtual subject (virtual object) at this time is an appearance of a reference that looks equal to the real subject (real object).

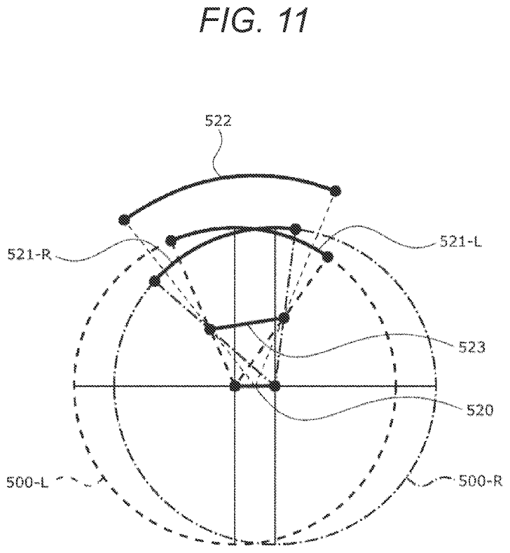

More specifically, as illustrated in FIG. 11, in a case where stereo camera image-capturing of a subject is performed with the camera inter-optical axis distance IPD_CAM set to 65 nu, and videos 500-L and 500-R corresponding to the captured left image and right image are attached to the entire celestial spheres for the left eye and the right eye, respectively, it is assumed that the virtual subject is viewed from the centers of the entire celestial spheres for the left eye and the right eye of the user with the user's interpupillary distance IPD_USER set to 65 mm.

At this time, a thick line 520 in the diagram corresponding to the distance between the virtual cameras placed at the centers of the entire celestial spheres for the left eye and the right eye coincides with the user's interpupillary distance IPD_USER. Furthermore, the user's interpupillary distance IPD_USER also coincides with the camera inter-optical axis distance IPD_CAM.

In FIG. 11, the range of the stereoscopic video seen in the left eye of the user is represented by a left angle of view 521-L, the range of the stereoscopic video seen in the right eye of the user is represented by a right angle of view 521-R, and the overall angle of view of the stereoscopic video is represented by an angle of view 522. Furthermore, in FIG. 11, a fused video is represented by a fusion video 523, and the angle of view 522 and the fusion video 523 correspond to the viewing angle 502 in FIG. 10.

Here, since the camera inter-optical axis distance IPD_CAM at the time of image-capturing coincides the user's interpupillary distance IPD_USER at the time of viewing, a stereoscopic video (captured video) viewed by the user appears equal to that in a case of direct viewing without passing through the cameras 11-L and 11-R. However, here, a description in principle is made in order to make it simple, but in practice it is necessary to consider distortion and the like in image-capturing.

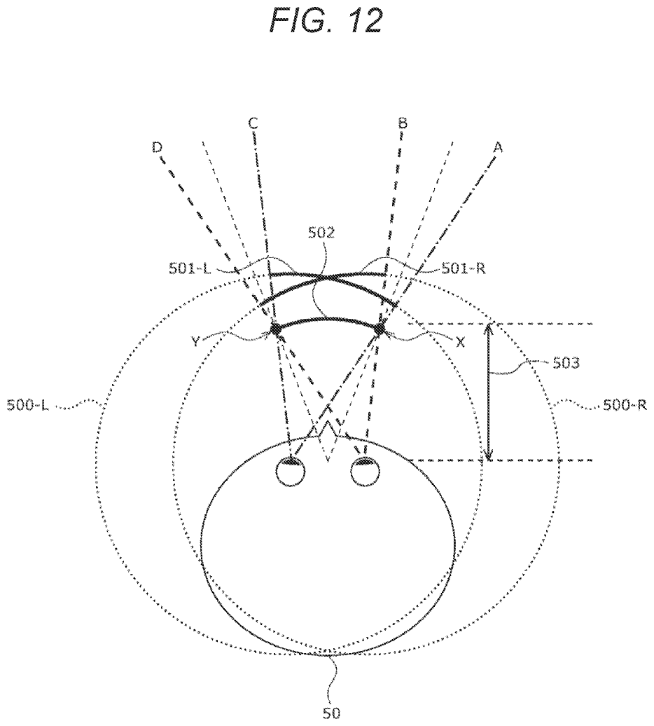

On the other hand, FIG. 12 schematically illustrates a state where the user wearing the display terminal 20 views the stereoscopic video when seen from above in the case where the relationship of IPD_CAM>IPD_USER occurs.

As illustrated in FIG. 12, the video displayed for the user 50 is the same as the video illustrated in FIG. 10. At this time, comparing the schematic diagram of FIG. 12 with the schematic diagram of FIG. 10, the viewing angle 502 of FIG. 12 is substantially the same as the viewing angle 502 of FIG. 10, but the fusion distance 503 of FIG. 12 is shorter than the fusion distance 503 of FIG. 10.

For this reason, under the condition of IPD_CAM>IPD_USER, while the size of the appearance is almost not optically changed, the fusion distance 503 is felt to be close and the virtual subject does not look so large even though the virtual subject is close, and consequently, the user feels that the virtual subject is small.

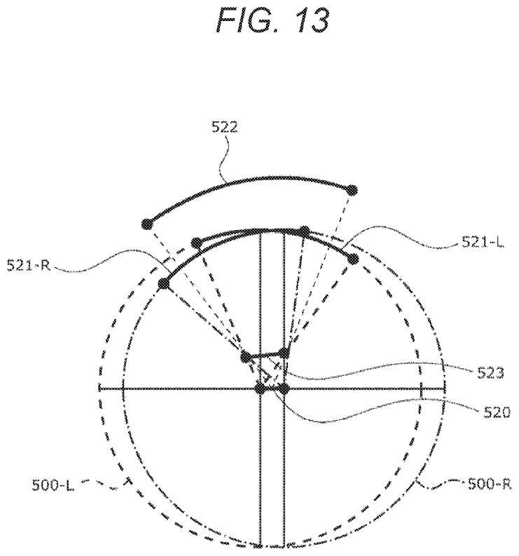

More specifically, as illustrated in FIG. 13, it is assumed that in a case where stereo camera image-capturing of the subject is performed with the camera inter-optical axis distance IPD_CAM set to 85 mm, and videos 500-L and 500-R corresponding to the captured left image and right image are attached to the entire celestial spheres for the left eye and the right eye, respectively, the virtual subject is viewed from the centers of the entire celestial spheres for the left eye and the right eye of the user with the user's interpupillary distance IPD_USER set to 65 mm.

At this time, the thick line 520 in the diagram corresponding to the distance between the virtual cameras placed at the centers of the entire celestial spheres for the left eye and the right eye coincides with the user's interpupillary distance IPD_USER, but the user's interpupillary distance IPD_USER does not coincide with the camera inter-optical axis distance IPD_CAM.

Here, since the camera inter-optical axis distance IPD_CAM at the time of image-capturing and the user's interpupillary distance IPD_USER at the time of viewing are in the relationship of IPD_CAM>IPD_USER, the entire celestial spheres to which the left and right videos 500-L and 500-R are attached are arranged inside the position considering the actual image-capturing position, and the overall scale becomes smaller. Thus, the stereoscopic video viewed by the user is seen closer than when directly viewed without passing through the cameras 11-L and 11-R.

Then, the user feels that the virtual subject is seen nearby even though the overall angle of view 522 (viewing angle 502) of the virtual subject does not change, and thus feels that the virtual subject seems small.

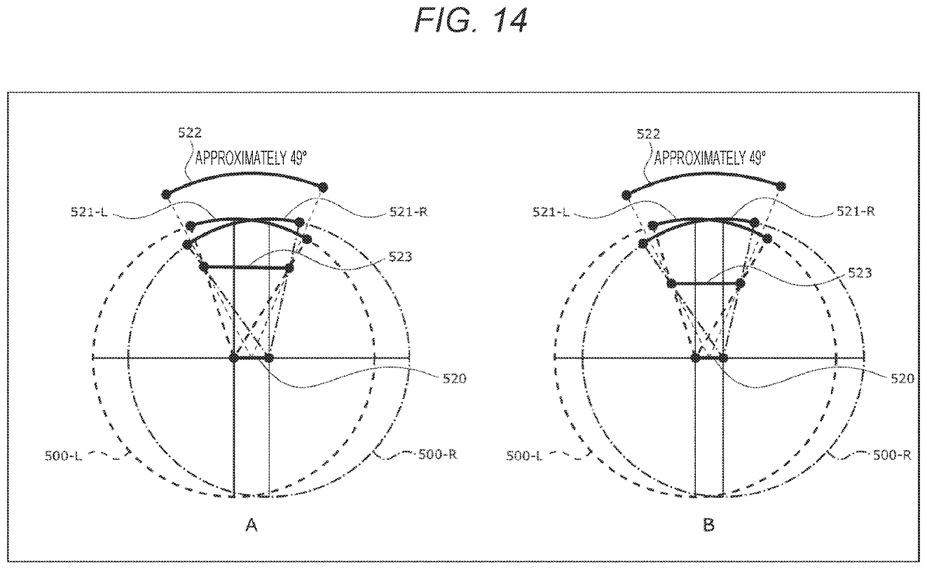

FIG. 14 illustrates in detail a state where the user views the stereoscopic video when IPD_CAM>IPD_USER in a case where the virtual subject (virtual object) is right in front.

A of FIG. 14 illustrates a state in the virtual space when it is assumed that the cameras 11-L and 11-R in the real space are installed at positions of black circles (●) at a left end and a right end of the thick line 520 in the diagram respectively as the camera inter-optical axis distance IPD_CAM and the subject is image-captured. On the other hand, B of FIG. 14 illustrates a state in the virtual space when the virtual subject corresponding to the subject that is image-captured in the state of A of FIG. 14 is viewed in a state where the left eye and the right eye (virtual cameras) of the user are located at positions of black circles (●) at a left end and a right end of the thick line 520 in the diagram as the user's interpupillary distance IPD_USER.

At this time, in A and B of FIG. 14, the overall angles of view 522 are both approximately 49° and are substantially the same angles, but the positions of the fusion videos 523 of the virtual subject right in front are different from the relationship of IPD_CAM>IPD_USER. That is, in B of FIG. 14, because the position of the fusion video 523 with respect to the thick line 520 in the diagram is closer as compared with that in A of FIG. 14, the user feels that the virtual subject right in front is viewed nearby, and the virtual subject seems small.

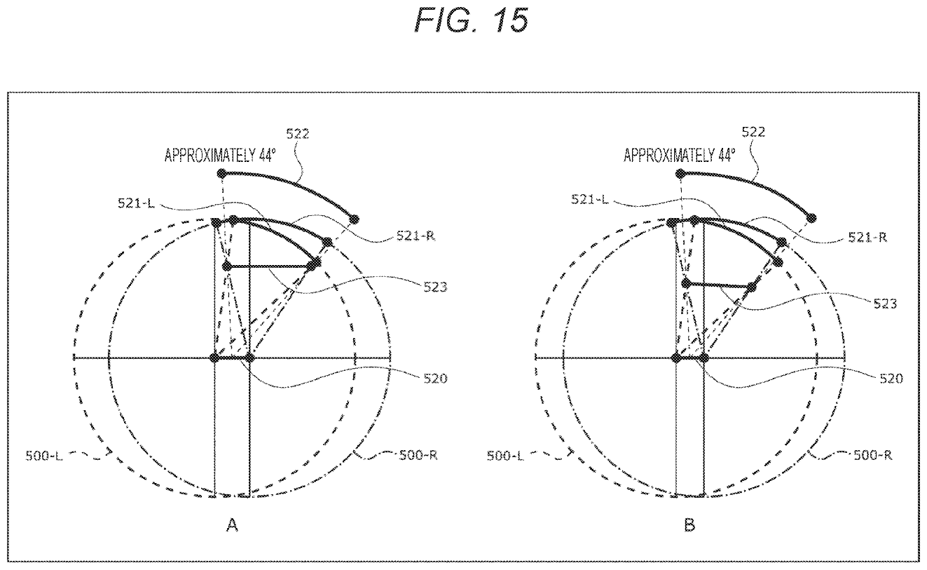

FIG. 15 illustrates in detail a state where the user views the stereoscopic video when IPD_CAM>IPD_USER in a case where the virtual subject (virtual object) is on the right front side.

In FIG. 15, similarly to FIG. 14 described above, positions of black circles (●) at a left end and a right end of the thick line 520 in the diagram correspond to the installation positions of the cameras 11-L and 11-R at the time of image-capturing (A of FIG. 15) and the positions of the left eye and the right eye of the user (B of FIG. 15), respectively.

At this time, in A and B of FIG. 15, the overall angles of view 522 are both approximately 440 and are substantially the same angles, but from the relationship of IPD_CAM>IPD_USER, in B of FIG. 15, since the position of the fusion video 523 with respect to the thick line 520 is closer as compared with that in A of FIG. 15, the user feels that the virtual subject on the right front side appears closer and this virtual subject seems small.

As described above, in a case where the camera inter-optical axis distance IPD_CAM of the stereo cameras that capture an image of the subject (real object) in the real space is different from the user's interpupillary distance IPD_USER in the virtual space (for example, in a case where the relationship of IPD_CAM>IPD_USER occurs), the size of the virtual subject (virtual object) corresponding to the subject in the virtual space looks different at the time of viewing by the user, and thus the user feels uncomfortable.

Therefore, in the present technology, a video can be more appropriately displayed by using three methods of the first method to the third method described below.

(First Method)

To begin with, a first method will be described with reference to FIGS. 16 to 21. The first method is a method of more appropriately displaying a video by shifting the viewing position of the user viewing the stereoscopic video from the centers of the entire celestial spheres.

FIG. 16 schematically illustrates an example of a state where the first method is applied in a case where the relationship of IPD_CAM>IPD_USER occurs.

FIG. 16 illustrates a state where the positions of the virtual cameras are moved forward from the centers of the entire celestial spheres, that is, a state where the viewing position of the user 50 wearing the display terminal 20 is brought close to the virtual subject in a case where the relationship between the camera inter-optical axis distance IPD_CAM and the user's interpupillary distance IPD_USER is a similar condition to that in FIG. 12 described above.

At this time, comparing the state of FIG. 16 with the state of FIG. 12, a fusion distance 603 is slightly shorter than the fusion distance 503, but a viewing angle 602 is significantly larger than the viewing angle 502. Thus, by adjusting this parameter, it is possible to make the virtual subject optically look large and cancel the influence that the fusion distance becomes short and the virtual subject consequently feels small.

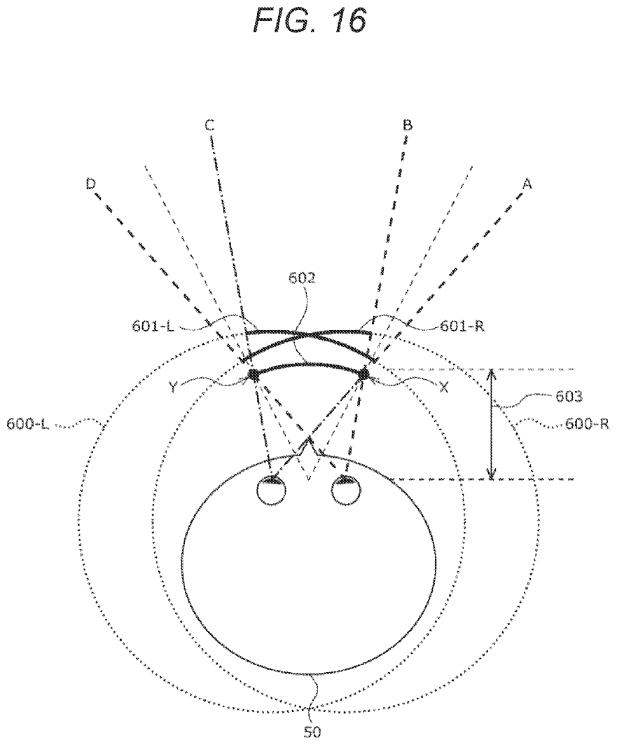

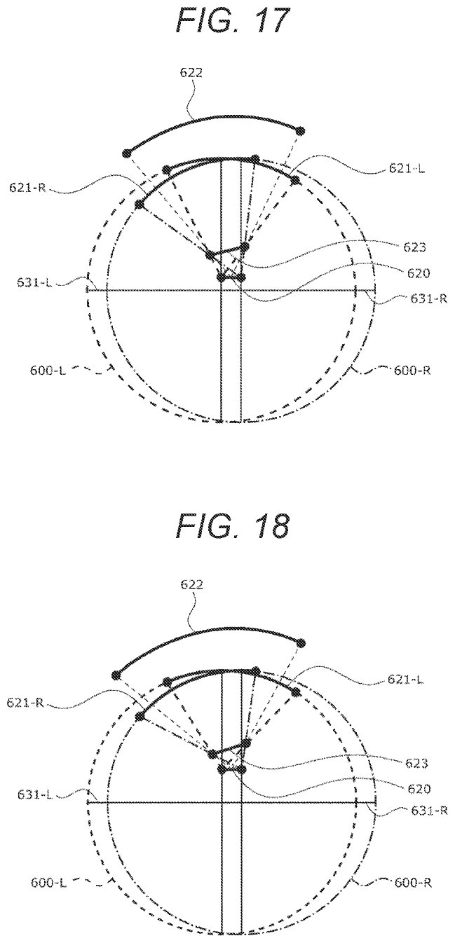

Furthermore, the example illustrated in FIG. 16 can also be grasped as follows from another aspect. That is, as illustrated in FIG. 17, it is assumed that in a case where the stereo camera image-capturing of the subject is performed with the camera inter-optical axis distance IPD_CAM set to 85 mm, and videos 600-L and 600-R corresponding to the captured left image and right image are projected (attached) on the entire celestial spheres for the left eye and the right eye, respectively, the viewing position of the user is shifted forward from the center of the entire celestial spheres.

Note that, in FIG. 17, the range of the stereoscopic video seen in the left eye of the user is represented by a left angle of view 621-L, the range of the stereoscopic video seen in the right eye of the user is represented by a right angle of view 621-R, and the overall angle of view of the stereoscopic video is represented by an angle of view 622. Moreover, in FIG. 17, the fused video is represented by a fusion video 623.

Furthermore, in FIG. 17, the intersection of a cross line 631-L described with respect to the video 600-L represents the center of the entire celestial sphere for the left eye on which the video 600-L is attached. Similarly, the intersection of a cross line 631-R described with respect to the video 600-R represents the center of the entire celestial sphere for the right eye on which the video 600-R is attached.

At this time, the user wearing the display terminal 20 has the user's interpupillary distance IPD_USER of 65 mm, and sees the virtual subject with the left eye and the right eye. That is, positions of black circles at a left end and a right end of a thick line 620 in the diagram correspond to the positions of the virtual cameras, but since the viewing position of the user is shifted forward, the viewing position of the user is shifted from the centers of the entire celestial spheres represented by the intersections of the cross lines 631-L and 631-R.

In other words, here, although the videos 600-L and 600-R corresponding to the left image and the right image-captured by the stereo cameras are attached to the entire celestial spheres for the left eye and the right eye, respectively, since the viewing position of the user is shifted forward, the virtual cameras are not placed at the respective centers of the entire celestial spheres for the left eye and the right eye, and it can be said that the user does not view from the respective centers of the entire celestial spheres for the left eye and the right eye.

In this manner, the viewing position of the user is shifted from the centers of the entire celestial spheres, and the positions of the left eye and the right eye of the user are respectively moved to the positions of the black circles at the left end and the right end of the thick line 620 in the diagram and brought close to the projection surface, so that the overall angle of view 622 of the virtual subject increases, and the user can feel this virtual subject large.

Consequently, it is possible to cancel the influence that the virtual subject feels small due to the relationship of IPD_CAM>IPD_USER, and the user can view the virtual subject (the virtual subject similar to the real subject) in a state closer to reality.

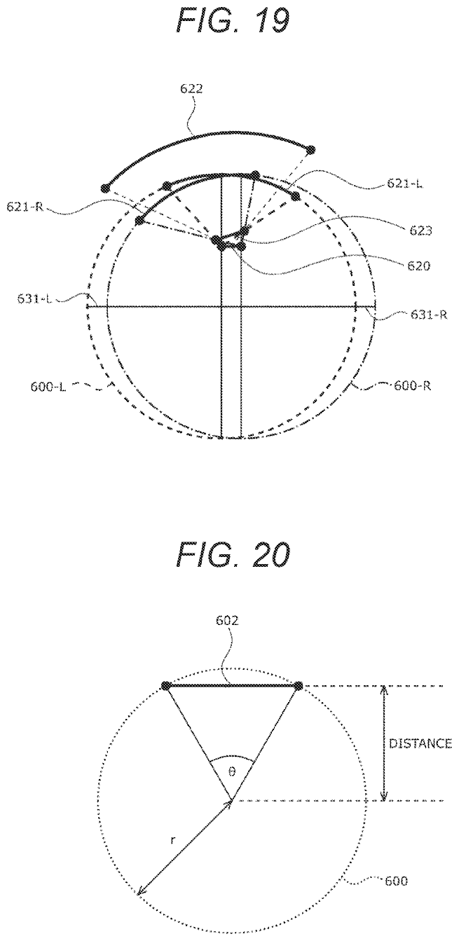

Note that, as illustrated in FIGS. 18 and 19, by further bringing the viewing position of the user closer to the projection surface, the overall angle of view 622 of the virtual subject is further increased, so that the virtual subject can be made to look larger.

(Schematic Diagram of Virtual Distance)

FIG. 20 schematically illustrates a concept of a virtual distance from the user to the virtual subject used when the conversion processing unit 300 performs the conversion processing.

In an entire celestial sphere 600 (or space 600) on which the video is projected, when the virtual subject (virtual object) looks like the viewing angle 602 as viewed from the user, the distance DISTANCE to the virtual subject can be expressed as following Equation (1) using a radius r and a viewing angle θ.

DISTANCE=r×cos(0.5θ) (1)

Furthermore, under the condition that the user's interpupillary distance IPD_USER and the camera inter-optical axis distance IPD_CAM do not coincide, it is assumed that the user sees the size of the virtual subject in a state of IPD_USER/IPD_CAM as compared with the subject in the real space. Thus, in order to guide a necessary post-movement distance, it is necessary to remove the influence thereof on the virtual subject actually seen.

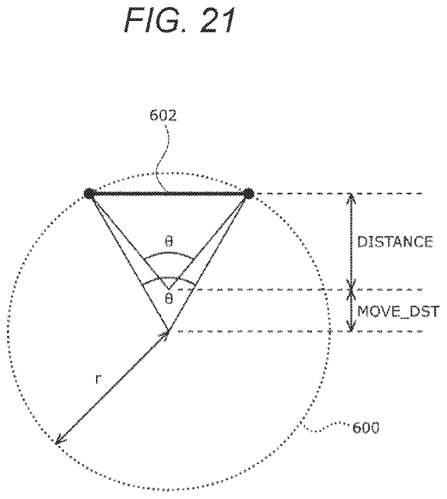

FIG. 21 schematically illustrates a state after the conversion processing is performed by the conversion processing unit 300, moving the positions of the virtual cameras (brought close) in the direction of the virtual subject.

Here, the movement distance MOVE_DST of the virtual camera can be represented as following Equation (2) using a movement ratio a with respect to a radius r of the sphere.

MOVE_DST=a×r (2)

Furthermore, the distance DISTANCE to the virtual subject after the movement can be represented as following Equation (3) from the relationship between Equation (1) and Equation (2).

DISTANCE=r×cos(0.5θ)−a×r (3)

Furthermore, the distance DISTANCE to the virtual subject after the movement can be further represented by a relationship of following Equation (4).

r×cos(0.5θ)−a×r=(IPD_USER/IPD_CAM)×r×cos(0.5θ) (4)

Then, by solving this, the desired movement ratio a can be expressed as following Equation (5).

a=cos(0.5θ)×(1−IPD_USER/IPD_CAM) (5)

Note that, at this time, it is assumed that there is almost no case where the viewing angle 602 of the virtual subject exceeds 10° in a state where the size of the entire subject can be recognized in a space due to human visual characteristics, including a case where a person is standing in front of the eyes, for example. Therefore, cos(0.5θ) can be regarded as substantially 1, and can be practically ignored even in light of the object of the present technology.

Therefore, Equation (5) can be represented as a=(1−IPD_USER/IPD_CAM), and the size of the virtual subject is unnecessary in the conversion processing.

As described above, in the first method, in a case where the camera inter-optical axis distance IPD_CAM and the user's interpupillary distance IPD_USER are different, the parameter is adjusted so that the viewing position of the user is shifted from the centers of the spherical surfaces (entire celestial spheres) on which the video is projected (the positions of the virtual cameras corresponding to the viewing position of the user is brought close to the projection surface of the spherical surface or away from the projection surface). Thus, the virtual subject corresponding to a state where the camera inter-optical axis distance IPD_CAM at the time of image-capturing coincides the user's interpupillary distance IPD_USER at the time of viewing is displayed.

That is, in the first method, by shifting the viewing position of the user viewing the stereoscopic video from the center of the entire celestial sphere, the influence that the virtual subject feels small due to the relationship of IPD_CAM>IPD_USER is canceled, and the virtual subject can be displayed in a state closer to reality.

That is, in a case where the relationship of IPD_CAM>IPD_USER occurs, the entire celestial spheres to which the videos 600-L and 600-R corresponding to the captured left image and right image are attached are arranged inside the positions considering the actual image-capturing positions, and the overall scale is reduced. Thus, the stereoscopic video viewed by the user appears closer than in a case where the stereoscopic video is directly viewed without passing through the cameras 11-L and 11-R. Then, from the user, even though the overall angle of view 622 (viewing angle 602) of the virtual subject has not changed, the user feels as if the virtual subject appears near and feels as if the virtual subject seems small.

On the other hand, in the first method, in a case where the relationship of IPD_CAM>IPD_USER occurs, the viewing position of the user is shifted from the centers of the entire celestial spheres and brought close to the projection surface, so that the overall angle of view 622 (viewing angle 602) of the virtual subject is changed (increased) to make it feel large. Consequently, the influence that the virtual subject feels small by the relationship of IPD_CAM>IPD_USER is canceled, and the virtual subject is displayed in a state closer to reality.

Note that, in the above description, the case where the user's viewing position is brought close to the projection surface to increase the sense of size of the virtual subject has been described, but conversely, in a case where it is desired to reduce the sense of size of the virtual subject, it is only required to move away the user's viewing position from the projection surface to reduce the overall angle of view 622 of the virtual subject.

Furthermore, in a case where the viewing position of the user is brought close to the projection surface, the angle of convergence increases, and the virtual subject is felt close, and meanwhile, in a case where the viewing position is moved away from the projection surface, the angle of convergence decreases, and the virtual subject is felt far. The influence of the angle of convergence is larger for an object closer, and is smaller for an object farther.

(Second Method)

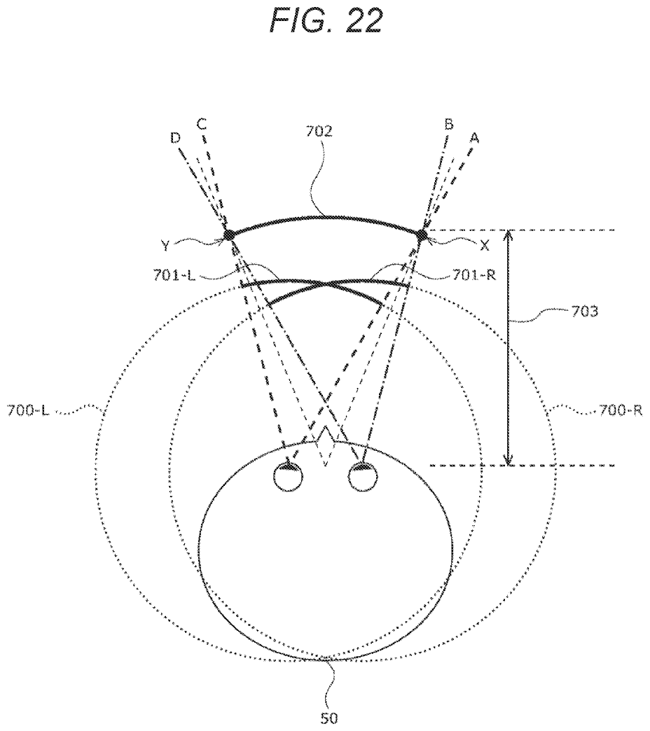

Next, the second method will be described with reference to FIGS. 22 to 26. The second method is a method of more appropriately displaying a video by rotating the videos to be attached to the entire celestial spheres.

FIG. 22 schematically illustrates an example of a state where the second method is applied in a case where the relationship of IPD_CAM>IPD_USER occurs.

FIG. 22 illustrates a state where videos 700-L and 700-R attached to the entire celestial spheres are rotated outward in a case where the relationship between the camera inter-optical axis distance IPD_CAM and the user's interpupillary distance IPD_USER is a similar condition to that in FIG. 12 described above.

In FIG. 22, the video 700-L corresponding to the left image attached to the entire celestial sphere for the left eye is rotated counterclockwise by a predetermined angle (for example, 5°), and the video 700-R corresponding to the right image attached to the entire celestial sphere for the right eye is rotated clockwise by a predetermined angle (for example, 5°).

At this time, when the state of FIG. 22 is compared with the state of FIG. 10, a viewing angle 702 has approximately the same size as the viewing angle 502, and a fusion distance 703 has approximately the same size as the fusion distance 503. Thus, by adjusting this parameter, it is considered that the appearance at this time is to appear equal to the actual subject with respect to at least the sense of size and the sense of distance in the left-right direction of the virtual subject.

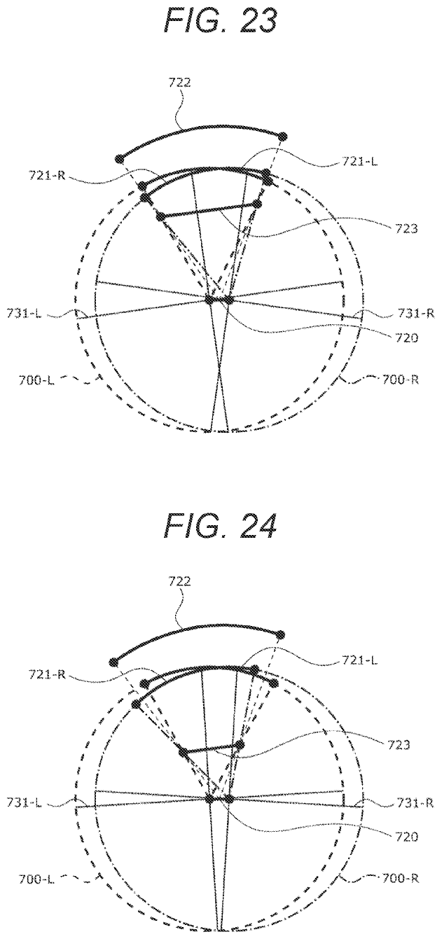

Furthermore, the example illustrated in FIG. 22 can also be grasped as follows from another aspect. That is, as illustrated in FIG. 23, it is assumed a case where the stereo camera image-capturing of the subject is performed with the camera inter-optical axis distance IPD_CAM set to 85 mm, the video 700-L corresponding to the captured left image is rotated counterclockwise by a predetermined angle and projected (attached) on the entire celestial sphere for the left eye, and the video 700-R corresponding to the captured right image is rotated clockwise by a predetermined angle and projected (attached) on the entire celestial sphere for the right eye, so that the videos 700-L and 700-R attached to the entire celestial spheres are rotated outward.

Note that, in FIG. 23, the range of the stereoscopic video seen in the left eye of the user is represented by a left angle of view 721-L, the range of the stereoscopic video seen in the right eye of the user is represented by a right angle of view 721-R, and the overall angle of view of the stereoscopic video is represented by an angle of view 722. Moreover, in FIG. 23, the fused video is represented by a fusion video 723.

Furthermore, in FIG. 23, a cross line 731-L described with respect to the video 700-L represents the rotation angle of the video 700-L attached to the entire celestial sphere for the left eye, and is in a state of being rotated counterclockwise by a predetermined angle from a reference state (a state where longitudinal and lateral lines of the cross line 731-L coincide with diameters in a vertical direction and a horizontal direction). Similarly, a cross line 731-R described with respect to the video 700-R represents the rotation angle of the video 700-R attached to the entire celestial sphere for the right eye, and is in a state of being rotated clockwise by a predetermined angle from a reference state (a state where the longitudinal and lateral lines of the cross line 731-R coincide with the diameters in the vertical direction and the horizontal direction).

At this time, the user wearing the display terminal 20 has the user's interpupillary distance IPD_USER of 65 mm, and sees the virtual subject according to the angle of view 722 with the left eye and the right eye. That is, the positions of the left eye and the right eye of the user are at positions of black circles at a left end and a right end of a thick line 720 in the diagram.

In other words, here, it can be said that the videos 700-L and 700-R corresponding to the left image and the right image-captured by the stereo camera are rotated outward and attached to the entire celestial spheres for the left eye and the right eye, respectively, and the user views from the centers of the entire celestial spheres for the left eye and the right eye (the virtual cameras are placed at the centers of the entire celestial spheres for the left eye and the right eye).

As described above, by rotating the videos 700-L and 700-R attached to the entire celestial sphere outward, if the rotation is a little rotation, the angle of view 722 (viewing angle 702) of the virtual subject hardly changes, and as the virtual subject is rotated outward, the virtual subject whose size does not change substantially looks farther, so that the user feels that the virtual subject is large.

Note that, for convenience of description, an example of extreme rotation is illustrated in FIG. 23, but in practice, rotation of the degree illustrated in FIG. 24 is also effective. That is, when the state of FIG. 24 is compared with the state of FIG. 13, although the videos to be attached to the entire celestial spheres are rotated outward, the angle of view 722 is substantially the same as the angle of view 522, and the fusion video 723 appears at a position farther from the viewing position of the user as compared with the fusion video 523.

Furthermore, as a method of rotating the videos 700-L and 700-R attached to the entire celestial spheres, in addition to the method of rotating the videos 700-L and 700-R and then attaching the videos 700-L and 700-R to the entire celestial spheres for the left eye and the right eye as described above, the videos 700-L and 700-R may be attached to the entire celestial spheres for the left eye and the right eye and then rotated together with the entire celestial spheres, and various implementations are possible.

Moreover, in a case where it is desired to reduce the sense of size of the virtual subject for the user, it is only required to rotate the videos 700-L and 700-R attached to the entire celestial spheres inward, contrary to the outward rotation described above. That is, by rotating the virtual subject inward, the virtual subject having substantially the same size can be seen nearby, so that the user feels that the virtual subject is small.

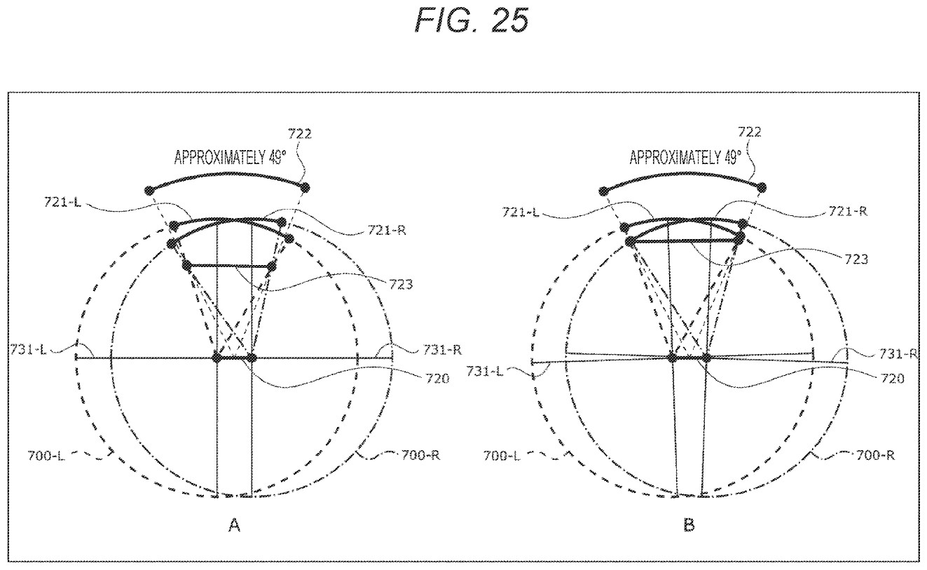

FIG. 25 illustrates a state where the videos 700-L and 700-R to be attached to the entire celestial spheres are rotated outward when IPD_CAM>IPD_USER in a case where the virtual subject (virtual object) is right in front.

B of FIG. 25 illustrates a state where the videos 700-L and 700-R attached to the entire celestial sphere are rotated outward by rotating the video 700-L attached to the entire celestial sphere for the left eye counterclockwise and rotating the video 700-R attached to the entire celestial sphere for the right eye clockwise from the state before the rotation in A of FIG. 25. At this time, in A and B of FIG. 25, the overall angles of view 722 are 49°, which are substantially the same angles. That is, with a small outward rotation, the angle of view 722 of the object hardly changes.

The effect before and after adjustment of the parameter for such outward rotation is an opposite effect to the state of FIG. 13 with respect to the state of FIG. 11 described above, that is, an effect similar to the effect in which the user's interpupillary distance IPD_USER at the time of viewing is widened with respect to the camera inter-optical axis distance IPD_CAM at the time of image-capturing. Thus, conversely, it is possible to obtain an effect in a direction of canceling the influence in a case where the user's interpupillary distance IPD_USER at the time of viewing is narrowed with respect to the camera inter-optical axis distance IPD_CAM at the time of image-capturing. Consequently, the user feels that the virtual subject is large.

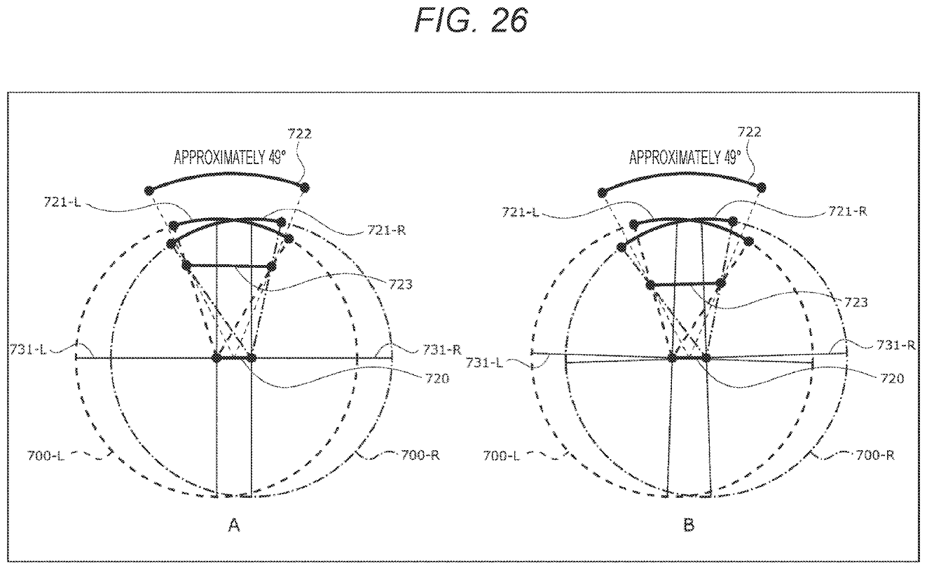

FIG. 26 illustrates a state where the videos 700-L and 700-R to be attached to the entire celestial spheres are rotated inward when IPD_CAM>IPD_USER in a case where the virtual subject (virtual object) is right in front.

B of FIG. 26 illustrates a state where the videos 700-L and 700-R attached to the entire celestial sphere are rotated inward by rotating the video 700-L attached to the entire celestial sphere for the left eye clockwise and rotating the video 700-R attached to the entire celestial sphere for the right eye counterclockwise from the state before the rotation in A of FIG. 26. At this time, in A and B of FIG. 26, the overall angles of view 722 are 49°, which are substantially the same angles. That is, with a small inward rotation, the angle of view 722 of the object hardly changes.

The effect before and after the adjustment of the parameter for such inward rotation is similar to the effect of the state of FIG. 13 with respect to the state of FIG. 11 described above, that is, an effect similar to the effect in which the user's interpupillary distance IPD_USER at the time of viewing is narrowed with respect to the camera inter-optical axis distance IPD_CAM at the time of image-capturing. Thus, conversely, it is possible to obtain an effect in a direction of canceling the influence in a case where the user's interpupillary distance IPD_USER at the time of viewing is widened with respect to the camera inter-optical axis distance IPD_CAM at the time of image-capturing. Consequently, the user feels that the virtual subject is small.

As described above, in the second method, in a case where the camera inter-optical axis distance IPD_CAM and the user's interpupillary distance IPD_USER are different, the parameter is adjusted so that the angle of the videos projected on the spherical surfaces (entire celestial spheres) changes (so as to rotate the videos projected on the spherical surfaces outward or inward) in a state where the viewing position of the user and the positions of the centers of the spherical surfaces (entire celestial spheres) on which the videos are projected coincide. Thus, the virtual subject corresponding to a state where the camera inter-optical axis distance IPD_CAM at the time of image-capturing coincides the user's interpupillary distance IPD_USER at the time of viewing is displayed.

That is, in the second method, by rotating the videos attached to the entire celestial spheres outward or inward, it is possible to cancel the influence in a case where the user's interpupillary distance IPD_USER at the time of viewing is narrowed or the user's interpupillary distance IPD_USER at the time of viewing is widened with respect to the camera inter-optical axis distance IPD_CAM at the time of image-capturing, and to display the virtual subject in a state closer to reality. That is, even in a state where the videos to be attached to the entire celestial spheres are rotated, it is possible to provide an influence of an appropriate appearance by logically guiding an appropriate value.

Note that in a case where the second method is used, because of a difference from an original light ray direction due to rotation of the videos to be attached to the entire celestial spheres, there is a possibility that distortion occurs or an event occurs in which the left and right eyes of the user look misaligned. Furthermore, when the rotation amounts of the videos to be attached to the entire celestial spheres become too large, there is a possibility that focusing is no longer performed, and thus it is necessary to adjust the rotation amounts to appropriate rotation amounts in adjusting the parameter.

(Third Method)

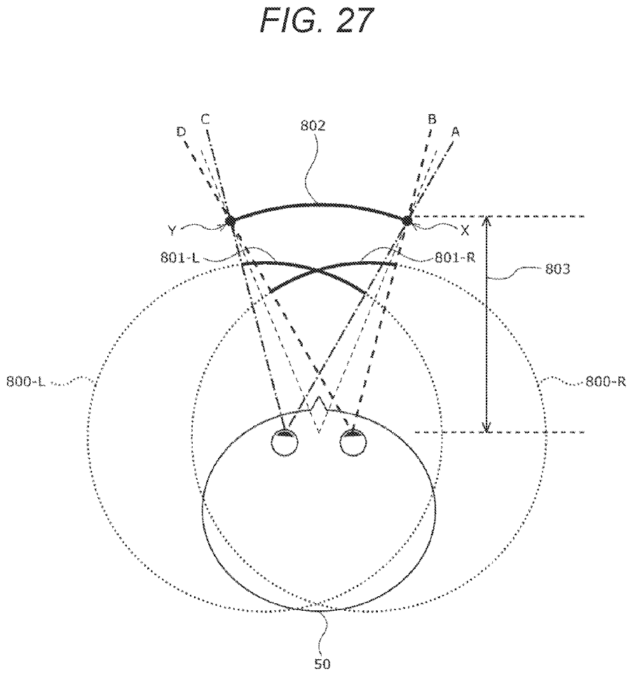

Finally, the third method will be described with reference to FIGS. 27 to 31. The third method is a method of displaying videos more appropriately by changing positions of the entire celestial spheres to which the videos are attached.

FIG. 27 schematically illustrates an example of a state where the third method is applied in a case where the relationship of IPD_CAM>IPD_USER occurs.

FIG. 27 illustrates a state where the center of the entire celestial sphere for the left eye to which the video 700-L corresponding to the left image is attached and the center of the entire celestial sphere for the right eye to which the video 700-R corresponding to the right image is attached are shifted outward in a case where the relationship between the camera inter-optical axis distance IPD_CAM and the user's interpupillary distance IPD_USER is a similar condition to that in FIG. 12 described above.

At this time, when the state of FIG. 27 is compared with the state of FIG. 12, a viewing angle 802 and a fusion distance 803 are changed to values closer to reality than the viewing angle 502 and the fusion distance 503.

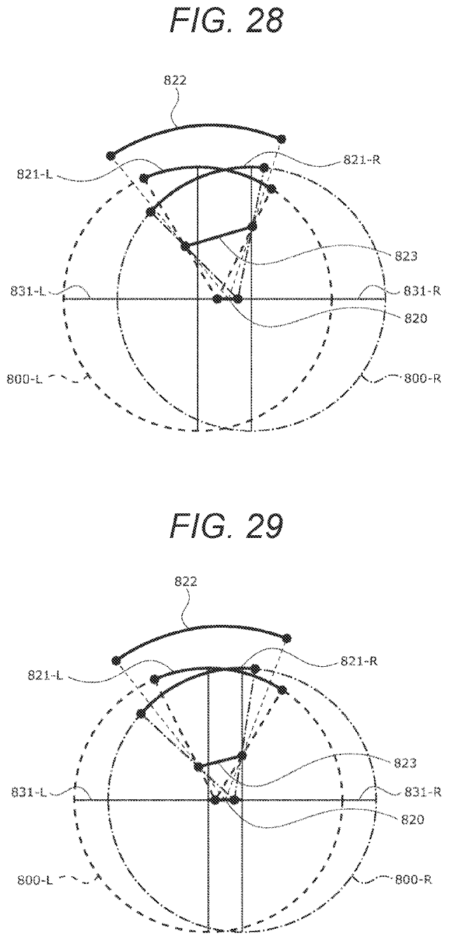

Furthermore, the example illustrated in FIG. 27 can also be grasped as follows from another aspect. That is, as illustrated in FIG. 28, it is assumed a case where the stereo camera image-capturing of the subject is performed with the camera inter-optical axis distance IPD_CAM set to 85 mm, a video 800-L corresponding to the captured left image is projected (attached) on the entire celestial sphere for the left eye, a video 800-R corresponding to the captured right image is projected (attached) on the entire celestial sphere for the right eye, and the centers of the entire celestial spheres for the left eye and the right eye are shifted outward.

Note that, in FIG. 28, the range of the stereoscopic video seen in the left eye of the user is represented by a left angle of view 821-L, the range of the stereoscopic video seen in the right eye of the user is represented by a right angle of view 821-R, and the overall angle of view of the stereoscopic video is represented by an angle of view 822. Moreover, in FIG. 28, the fused video is represented by a fusion video 823.

Furthermore, in FIG. 28, the intersection of a cross line 831-L described with respect to the video 800-L represents the center of the entire celestial sphere for the left eye to which the video 800-L is attached, and is in a state of being moved in the horizontal direction so as to separate from a right end (the position of the right eye of the user) of a thick line 820 in the diagram. Similarly, the intersection of a cross line 831-R described with respect to the video 800-R represents the center of the entire celestial sphere for the right eye to which the video 800-R is attached, and is in a state of being moved in the horizontal direction so as to separate from a left end (the position of the left eye of the user) of the thick line 820 in the diagram.

At this time, the user wearing the display terminal 20 has the user's interpupillary distance IPD_USER of 65 mm, and sees the virtual subject according to the angle of view 822 with the left eye and the right eye. That is, positions of black circles at a left end and a right end of the thick line 820 in the diagram correspond to the position of the virtual camera, but since the center of the entire celestial sphere for the left eye and the right eye is shifted outward, the viewing position of the user is shifted from the center of the entire celestial sphere.

In other words, here, the videos 800-L and 800-R corresponding to the left image and the right image-captured by the stereo camera are attached to the entire celestial spheres for the left eye and the right eye, respectively, but since the centers of the entire celestial sphere for the left eye and the right eye are shifted outward, the virtual camera is not placed at the respective centers of the entire celestial spheres for the left eye and the right eye, and the user does not view from the center of each of the entire celestial sphere for the left eye and the right eye.

As described above, even if the centers of the entire celestial spheres to which the videos 800-L and 800-R are attached are shifted outward, the angle of view 822 (viewing angle 802) of the virtual subject does not change, and as the entire celestial sphere is shifted outward, the virtual subject whose size does not change appears farther, so that the user feels that the virtual subject is large.

Note that, for convenience of description, FIG. 28 illustrates an example of shifting extremely, but in practice, a shift amount of a degree illustrated in FIG. 29 is also effective. That is, when the state of FIG. 28 is compared with the state of FIG. 13, although the entire celestial spheres are shifted outward from the center, the angle of view 822 is substantially the same as the angle of view 522, and the fusion video 823 appears at a position farther from the viewing position of the user as compared with the fusion video 523.

Moreover, in a case where it is desired to reduce the sense of size of the virtual subject for the user, it is only required to shift the centers of the entire celestial spheres to which the videos 800-L and 800-R are attached inward, conversely to shifting outward as described above. That is, by shifting the entire celestial spheres inward, the virtual subject having substantially the same size can be seen nearby, and thus the user feels that the virtual subject is small.

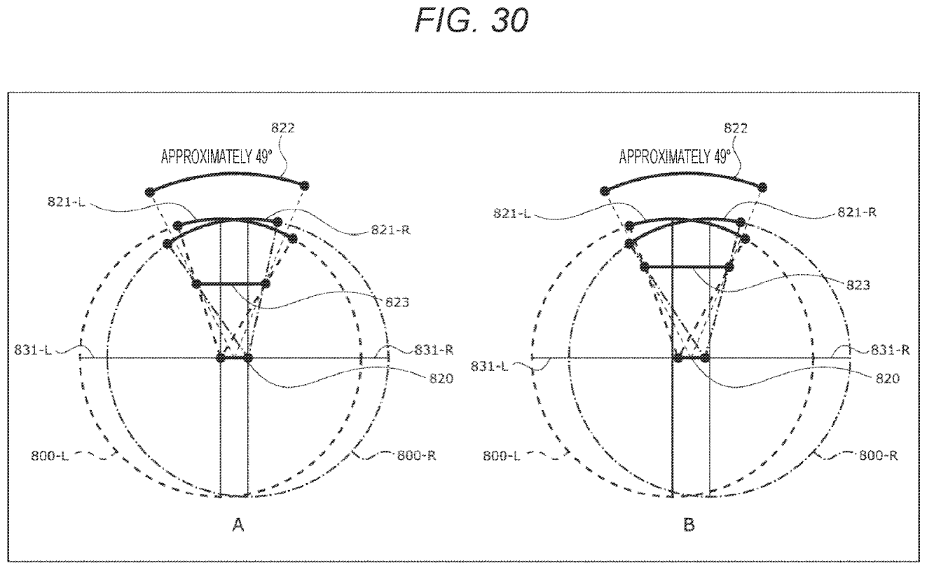

FIG. 30 illustrates a state in which, in a case where the virtual subject (virtual object) is right in front, when IPD_CAM>IPD_USER, the centers of the entire celestial spheres to which the videos 800-L and 800-R are attached are moved outward.

B of FIG. 30 illustrates a state in which, from the state before the movement in A of FIG. 30, the center of the entire celestial sphere for the left eye to which the video 800-L is attached (intersection of the cross line 831-L) is moved in the horizontal direction so as to separate from the right end of the thick line 820 in the diagram (position of the right eye of the user), and the center of the entire celestial sphere for the right eye to which the video 800-R is attached (intersection of the cross line 831-R) is moved in the horizontal direction so as to separate from the left end of the thick line 820 in the diagram (position of the left eye of the user), so that the center of the entire celestial sphere to which the videos 800-L and 800-R are attached is moved outward. At this time, in both A and B of FIG. 30, the overall angles of view 822 are 49°, which are substantially the same angles. That is, when the entire celestial spheres are slightly shifted outward, the angle of view 822 of the target hardly changes.

Such an effect before and after adjustment of the parameter for shifting the centers of the entire celestial spheres outward is opposite to the effects in the state of FIG. 13 with respect to the state of FIG. 11 described above, that is, similar to the effect in which the user's interpupillary distance IPD_USER at the time of viewing is widened with respect to the camera inter-optical axis distance IPD_CAM at the time of image-capturing. Thus, conversely, it is possible to obtain an effect in a direction of canceling the influence in a case where the user's interpupillary distance IPD_USER at the time of viewing is narrowed with respect to the camera inter-optical axis distance IPD_CAM at the time of image-capturing. Consequently, the user feels that the virtual subject is large.

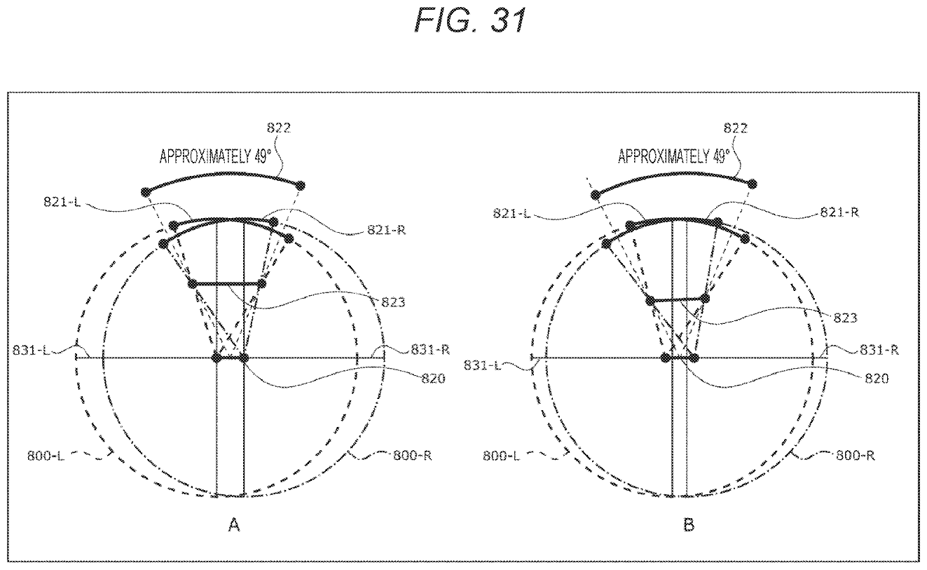

FIG. 31 illustrates a state in which, in a case where the virtual subject (virtual object) is right in front, when IPD_CAM>IPD_USER, the centers of the entire celestial spheres to which the videos 800-L and 800-R are attached are moved inward.

B of FIG. 31 illustrates a state in which, from the state before the movement in A of FIG. 31, the center of the entire celestial sphere for the left eye to which the video 800-L is attached (the intersection of the cross line 831-L) is moved in the horizontal direction so as to approach the right end of the thick line 820 in the diagram (the position of the right eye of the user), and the center of the entire celestial sphere for the right eye to which the video 800-R is attached (the intersection of the cross line 831-R) is moved in the horizontal direction so as to approach the left end of the thick line 820 (the position of the left eye of the user), so that the center of the entire celestial sphere to which the videos 800-L and 800-R are attached is moved inward. At this time, in both A and B of FIG. 31, the overall angles of view 822 are 49°, which are substantially the same angles. That is, when the entire celestial spheres are slightly shifted inward, the angle of view 822 of the target hardly changes.

Such an effect before and after adjustment of the parameter for shifting the centers of the entire celestial spheres inward is similar to the effects in the state of FIG. 13 with respect to the state of FIG. 11 described above, that is, similar to the effect in which the user's interpupillary distance IPD_USER at the time of viewing is narrowed with respect to the camera inter-optical axis distance IPD_CAM at the time of image-capturing. Thus, conversely, it is possible to obtain an effect in a direction of canceling the influence in a case where the user's interpupillary distance IPD_USER at the time of viewing is widened with respect to the camera inter-optical axis distance IPD_CAM at the time of image-capturing. Consequently, the user feels that the virtual subject is small.

As described above, in the third method, in a case where the camera inter-optical axis distance IPD_CAM and the user's interpupillary distance IPD_USER are different, the parameter is adjusted so that the centers of the spherical surfaces (entire celestial spheres) on which the videos are projected are shifted from the viewing position of the user (the positions of the centers of the spherical surfaces are moved outward or inward with respect to the positions of the virtual cameras corresponding to the viewing position of the user). Thus, the virtual subject corresponding to a state where the camera inter-optical axis distance IPD_CAM at the time of image-capturing coincides the user's interpupillary distance IPD_USER at the time of viewing is displayed.

That is, in the third method, by moving the centers of the entire celestial spheres to which the videos are attached to an outside or an inside, it is possible to cancel the influence in a case where the user's interpupillary distance IPD_USER at the time of viewing is narrowed or the user's interpupillary distance IPD_USER at the time of viewing is widened with respect to the camera inter-optical axis distance IPD_CAM at the time of image-capturing, and to display the virtual subject in a state closer to reality. That is, even in a state where the centers of the entire celestial spheres to which the videos are attached are moved, it is possible to provide an influence of an appropriate appearance by logically guiding an appropriate value.

Note that, in a case where the third method is used, the viewing position of the user is shifted from the centers of the entire celestial spheres by moving the centers of the entire celestial spheres to which the videos are attached. Thus, the above-described “as long as the user 50 does not move the eye positions (only moves the eyeballs), the stereoscopic video can be correctly viewed” does not hold true, and there is a possibility that it looks shifted for the left and right eyes. Furthermore, when the entire celestial spheres are moved too much from the center, there is a possibility that focusing is no longer performed (as the deviation amount is larger, the sense of size appears to change, and the influence of change in appearance also increases), and thus adjustment to an appropriate deviation amount is necessary when the parameter is adjusted.

### 2. Modification Example

In the above description, a case where each of the first method to the third method is performed as an independent method has been described. On the other hand, any of the first method in which the viewing position of the user is shifted from the centers of the entire celestial spheres, the second method in which the videos to be attached to the entire celestial spheres are rotated, and the third method in which the centers of the entire celestial spheres to which the videos are attached are shifted has a possibility to cause distortion having some characteristics different from each other in the video. Accordingly, in order to suppress side effects according to each method, at least two methods among the first method to the third method may be performed in combination.

For example, in a case where the first method is applied and the viewing position of the user is moved forward, if the subject is present near the camera at the time of image-capturing, a phenomenon that the subject looks excessively close may occur. As described above, the second method and the third method also have side effects, and the larger the adjustment amount (correction amount) of the parameter, the greater the influence.

In the present modification example, by combining any two methods or three methods to reduce the adjustment amount (correction amount) of the parameter according to each method, it is possible to control the appearance of the sense of size of the virtual subject while suppressing side effects according to each method.

For example, in a case where the first method is applied, as the adjustment of the parameter when the viewing position of the user is moved forward, the adjustment is suppressed to such an extent that is not excessive, and the remaining portion that has not been adjusted is adjusted in accordance with another method. Thus, since the parameters are adjusted according to a plurality of methods, it is possible to provide an appropriate video appearance while minimizing distortion due to each adjustment.

Furthermore, since the change in the appearance of the video due to conversion processing to which the present technology is applied can be logically predicted, a content creator, a producer, or the like can also control the appearance of the video using this adjustment logic. Specifically, desired performance can be achieved by setting the movement ratio a, which is a parameter included in above-described Equation (2) or the like, to an excessively small value or an excessively large value within a range in which there is no problem in visual load of the user and within a range in which there is no problem of distortion of the video in quality.

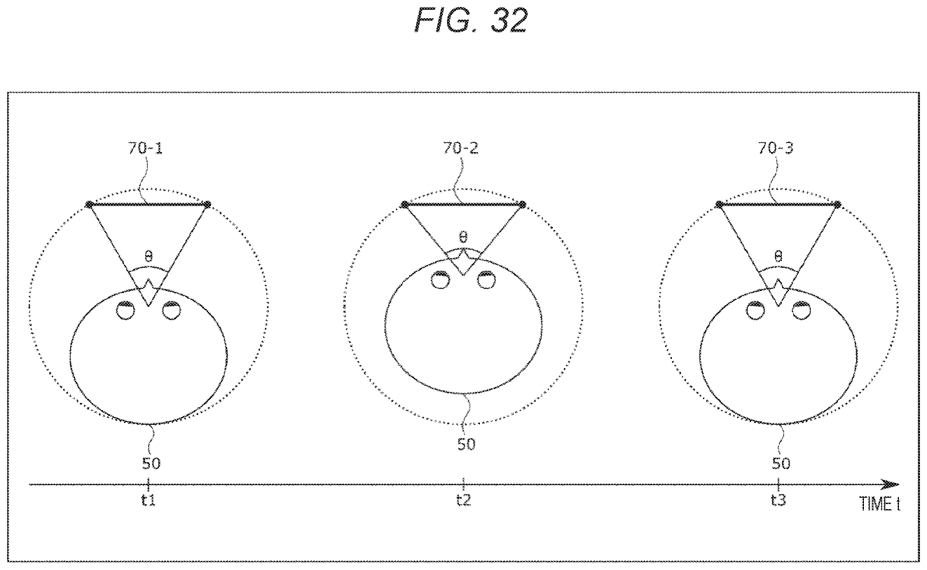

This performance may be changed in time series. For example, as illustrated in FIG. 32, after a virtual subject 70-1 in a default state is displayed at time t1, the first method is applied at time t2 to display a virtual subject 70-2 by bringing the viewing position of the user 50 closer to the projection surface. Then, at subsequent time t3, display of a virtual subject 70 can be freely switched at an arbitrary timing in time series, such as displaying a virtual subject 70-3 at a time of scene switching.

Furthermore, in addition to the viewpoint of such performance, in view of viewability of video, a viewing trend of an individual user, and the like, for example, when the user performs the zoom operation or when it is better to reduce the load, the timing at which the parameter should be changed (adjusted) can be input in advance at a time of content creation or the like. Alternatively, for example, the parameter may be adjusted by inputting various conditions other than the content of video, such as changing (adjusting) the parameter according to an operation of the user, changing (adjusting) the parameter according to a viewing time, or controlling in real time over the Internet 30 via a predetermined device.

That is, the above description has particularly exemplified the case where the virtual subject corresponding to the state in which the camera inter-optical axis distance IPD_CAM and the user's interpupillary distance IPD_USER coincide is displayed in a case where the camera inter-optical axis distance IPD_CAM and the user's interpupillary distance IPD_USER are different due to adjustment of the parameter as the first method to the third method, but the display form of the virtual subject corresponding to the adjusted parameter is not limited thereto. For example, the parameter may be adjusted such that a virtual subject (for example, a virtual subject having an appearance different from that of a real subject) corresponding to a state in which the camera inter-optical axis distance IPD_CAM and the user's interpupillary distance IPD_USER are different from each other is displayed in a case where the camera inter-optical axis distance IPD_CAM and the user's interpupillary distance IPD_USER coincide or are different from each other.

Note that, in the above description, although the time when IPD_CAM>IPD_USER in a case where the display terminal 20 is a head mounted display has been mainly described, the present technology can also be applied to a case where an information terminal such as a smartphone is used as the display terminal 20 to implement an augmented reality (AR) function of displaying a video captured by a camera of the information terminal in a see-through manner on a display unit of the information terminal.

In this case, the display terminal 20 as an information terminal such as a smartphone has a function of an imaging device (a function corresponding to the camera 11) in addition to the reproduction unit 220 and the conversion processing unit 300. Here, in a case where an information terminal such as a smartphone is used, it is also assumed that IPD_USER>IPD_CAM. Even in such a case, by applying the present technology and appropriately adjusting a parameter that affects an appearance to the user regarding the virtual subject (for example, a sense of size, a sense of distance, or the like of the virtual subject), it is possible to appropriately display a video such as making it appear equal to a real subject.

Furthermore, in the above description, the case where the display terminal 20 includes the reproduction unit 220 and the display unit 203 has been described, but a configuration may be provided in which the display terminal 20 including the display unit 203 does not include the reproduction unit 220 by separately providing a reproduction device including the reproduction unit 220. Moreover, the functions of the workstation 10 and the functions of the video distribution server 12 may be combined (integrated) to be configured as one device.

That is, in the video distribution system 1, which device includes the components (processing units) constituting each device of the workstation 10, the camera 11, the video distribution server 12, and the display terminal 20 is arbitrary. In other words, the system means a set of a plurality of components (devices, modules (parts), and the like), and it does not matter whether or not all components are in the same housing.

Therefore, both of a plurality of devices housed in separate housings and connected via a network and a single device in which a plurality of modules is housed in one housing are systems. Furthermore, a communication form of each component is also arbitrary. In other words, the components may be connected via the Internet 30 or may be connected via a local net (local area network (LAN) or wide area network (WAN)). Further, the components may be connected by wire or wirelessly.

Moreover, in the above description, the stereoscopic video is not limited to a moving image such as a VR moving image, and includes a video such as a still image. Furthermore, in the above description, it has been described that the virtual space is achieved by projecting the respective videos corresponding to the left image and the right image captured by the cameras 11-L and 11-R configured as stereo cameras on the entire celestial spheres for the left eye and the right eye, respectively. The entire celestial sphere is an example of the projection surface, and may be projected on another spherical surface such as a half celestial sphere, an inner surface of a cylinder, a plane that covers the user's field of view by approximately 180°, or the like.

As described above, the video distribution system 1 to which the present technology is applied includes an image acquisition unit (for example, the image acquisition unit 111 of the processing unit 100 of the workstation 10) that acquires a left image and a right image of a subject (for example, the subject 60) captured by the camera 11-L the camera 11-R, a parameter adjustment unit (for example, the parameter adjustment unit 320 of the conversion processing unit 300) that adjusts a parameter that affects an appearance to a user (for example, the sense of size, the sense of distance, or the like of a virtual subject) regarding a virtual subject corresponding to the subject in a virtual space represented by the left image and the right image that have been acquired, and a display control unit (for example, the display control unit 213 of the processing unit 200 of the display terminal 20) that displays a video (for example, videos 600-L, 600-R, and the like) representing the virtual space including the virtual subject corresponding to the adjusted parameter on a display terminal (for example, the display unit 203 of the display terminal 20).

That is, in the video distribution system 1 to which the present technology is applied, as the parameter that affect the appearance to the user, such as the sense of size and the sense of distance of the virtual subject, for example, a parameter related to at least one of the camera inter-optical axis distance IPD_CAM, the user's interpupillary distance IPD_USER, the distance to the virtual subject, or the size of the virtual subject (for example, a parameter correlated with a relationship between the camera inter-optical axis distance IPD_CAM and the user's interpupillary distance IPD_USER) is adjusted (for example, each of the first method to the third method is performed as a single method, or at least two of the first method to the third method are performed in combination), so that the video (stereoscopic video) can be displayed more appropriately.

Furthermore, the influence of the camera inter-optical axis distance IPD_CAM, which is limited by the size of a camera body and the lens in the camera 11, other image-capturing environments, and the like, is eliminated or reduced, which increases the degree of freedom of options of the camera body and the lens, thereby making it possible to select optimal equipment suitable for various environments and subjects. Consequently, content that has conventionally been difficult to convey the size and the sense of distance of an actual subject can be reproduced in a state closer to the actual subject.

Moreover, it is possible to adjust a difference in appearance of the virtual subject between individuals by the user's interpupillary distance IPD_USER, and thus the level of video experience for each user can be unified. Specifically, when the user views the content including the video performance using the size and the sense of distance, it is possible to appropriately convey the purpose of the performance to the user.

Furthermore, it is possible to provide an optimal video experience for each individual user by adjusting to the size and the sense of distance according to the user's preference within a range in which the value of the content is not lost. Here, the size and the sense of distance can be adjusted not only for accuracy and user's personal preference but also for performance. Moreover, when the present technology is applied to a system that performs physical action depending on the size of appearance and sense of distance of a partner in remote communication or the like, it is possible to reduce a difference in experience between reality and virtual reality (VR).

Note that Patent Document 1 described above proposes a technique for adjusting the appearance of stereoscopic vision. In this technical proposal, an approach of allowing a user to make an adjustment using a user interface (UI) is employed, but there are problems in actual operation in the following two points. That is, first, depending on user's adjustment, there is a possibility that the use is continued in an inappropriate state where a visual load is applied, and second, the content provider side cannot grasp what size it appears to the user, and accordingly, it becomes impossible to unify the video experience for each user.

On the other hand, in the present technology, since the optimum state is presented to logically reproduce the appearance at the time of image-capturing, the two problems described above do not occur. Note that, also in the present technology, a method in which the user selects visually preferable ones as in the technology disclosed in Patent Document 1 is described as one of options of a method of adjusting the appearance without using theoretical values, but it is possible in principle to perform presentation while excluding an option that is visually burdensome when presented to the user and an option that is considered that the video experience cannot be unified, so that the two problems described above do not occur.

Furthermore, Patent Document 2 described above proposes a technique for correcting the influence of impairing the realistic feeling of the video depending on the magnitude relationship between the distance between the subject and the camera and the distance between the display device and the user. In this technical proposal, an approach of adjusting the size of the appearance of the subject by changing the angle of the camera at the time of image-capturing is employed. However, with this method, a large distortion of the video occurs at a short distance, the immersive feeling is thereby weakened particularly in an environment where a video of virtual reality (VR) is viewed, and consequently the quality is deteriorated and it becomes difficult to put the technique into practical use. Furthermore, the technique depends on the angle of the camera at the time of image-capturing, it is not possible to add correction after image-capturing once.

On the other hand, in the present technology, since one or a plurality of parameters can be adjusted according to the three methods of the first method to the third method or the like after image-capturing the subject, it is possible to cope with various distances, and moreover, conversion processing (parameter adjustment) is achieved by post-processing on a captured video (image), so that such a problem does not occur.

Note that, in the related art other than Patent Documents 1 and 2 described above, methods for adjusting a sense of distance and a sense of size have been proposed for a stereoscopic display such as a television set compatible with 3D, but these methods mainly correct a sense of size of a subject due to a difference in a device that displays a video or a viewing position of a user. In addition, basically, in such a viewing environment, the user cannot see a subject as an “actual object itself” and cannot request high accuracy.

On the other hand, when a video of virtual reality (VR) is viewed on the display terminal 20 such as a head mounted display, a space to a virtual subject and front, rear, left, and right information are reproduced, and from the user, the immersive feeling is high and the virtual subject looks as a subject (“actual object itself”). Therefore, more accurate adjustment (parameter adjustment) is required in the sense of distance to the subject and the sense of size, and it can be said that the approach of the present technology considering the characteristics of the display terminal 20 including the head mounted display is appropriate.

### 3. Configuration Example of Computer

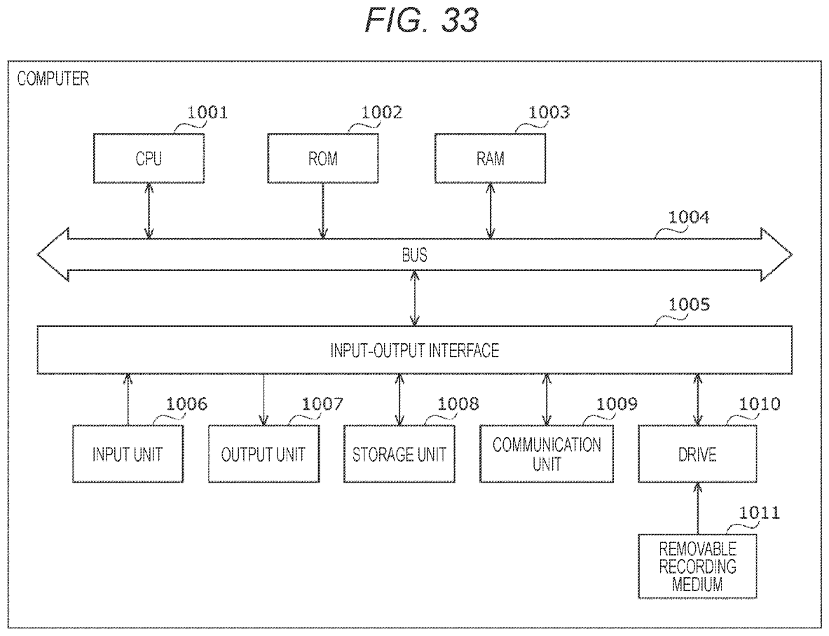

The above-described series of processes (for example, the processing of the entire system illustrated in FIG. 9) can be executed by hardware or software. In a case where the series of processes is executed by software, a program constituting the software is installed in a computer of each device. FIG. 33 is a block diagram illustrating a configuration example of hardware of a computer that executes the above-described series of processes by a program.

In the computer of FIG. 33, a central processing unit (CPU) 1001, a read only memory (ROM) 1002, and a random access memory (RAM) 1003 are interconnected via a bus 1004. An input-output interface 1005 is further connected to the bus 1004. An input unit 1006, an output unit 1007, a storage unit 1008, a communication unit 1009, and a drive 1010 are connected to the input-output interface 1005.

The input unit 1006 includes a microphone, a keyboard, a mouse, and the like. The output unit 1007 includes a speaker, a display, and the like. The storage unit 1008 includes a hard disk, a nonvolatile memory, and the like. The communication unit 1009 includes a network interface and the like. The drive 1010 drives a removable recording medium 1011 such as a magnetic disk, an optical disk, a magneto-optical disk, or a semiconductor memory.

In the computer configured as described above, the CPU 1001 loads a program recorded in the ROM 1002 or the storage unit 1008 into the RAM 1003 via the input-output interface 1005 and the bus 1004 and executes the program, so as to perform the above-described series of processes.

The program executed by the computer (CPU 1001) can be provided by being recorded on the removable recording medium 1011 as a package medium or the like. Furthermore, the program can be provided via a wired or wireless transmission medium such as a local area network, the Internet, or digital satellite broadcasting.

In the computer, the program can be installed in the storage unit 1008 via the input-output interface 1005 by mounting the removable recording medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Here, in the present description, the processing performed by the computer according to the program does not necessarily have to be performed in time series in the order described as the flowchart. That is, the processing performed by the computer according to the program also includes processing that is executed in parallel or individually (for example, parallel processing or object processing). Furthermore, the program may be processed by one computer (processor) or may be processed in a distributed manner by a plurality of computers.

Note that the embodiments of the present technology are not limited to the above-described embodiments, and various modifications are possible without departing from the gist of the present technology.

Furthermore, each step of the processing of the entire system illustrated in FIG. 9 can be executed by one device or can be shared and executed by a plurality of devices. Moreover, in a case where a plurality of processes is included in one step, the plurality of processes included in the one step can be executed in a shared manner by a plurality of devices in addition to being executed by one device.

Note that the present technology can also employ the following configurations.

(1)

A video distribution system including:

an image acquisition unit that acquires a first image and a second image of a subject captured by a first camera and a second camera;

a parameter adjustment unit that adjusts a parameter that affects an appearance to a user regarding a virtual subject corresponding to the subject in a virtual space represented by the first image and the second image that have been acquired; and

a display control unit that displays a video representing the virtual space including the virtual subject corresponding to the adjusted parameter on a display terminal.

(2)

The video distribution system according to (1), in which

the parameter includes a parameter related to at least one of a first distance between the first camera and the second camera, a second distance between pupils of the user, a distance to the virtual subject, or a size of the virtual subject.

(3)

The video distribution system according to (2), in which

the parameter includes a parameter correlated with a relationship between the first distance and the second distance.

(4)

The video distribution system according to (3), in which

in a case where the first distance and the second distance are different, the parameter adjustment unit adjusts the parameter in such a manner that the virtual subject corresponding to a state where the first distance and the second distance coincide is displayed.

(5)

The video distribution system according to (4), in which

the parameter adjustment unit adjusts the parameter in such a manner that a viewing position of the user is shifted from a center of a spherical surface on which a video is projected.

(6)

The video distribution system according to (5), in which

the parameter adjustment unit brings a position of a virtual camera corresponding to the viewing position of the user close to a projection surface of the spherical surface or away from the projection surface.

(7)

The video distribution system according to any one of (4) to (6), in which

the parameter adjustment unit adjusts the parameter in such a manner that, in a state where the viewing position of the user and a position of a center of a spherical surface on which a video is projected coincide, an angle of the video projected on the spherical surface changes.

(8)

The video distribution system according to (7), in which

the parameter adjustment unit rotates the video projected on the spherical surface outward or inward.

(9)

The video distribution system according to any one of (4) to (8), in which

the parameter adjustment unit adjusts the parameter in such a manner that a center of a spherical surface on which a video is projected is shifted from a viewing position of the user.

(10)

The video distribution system according to (9), in which

the parameter adjustment unit moves a position of the center of the spherical surface outward or inward with respect to a position of a virtual camera corresponding to the viewing position of the user.

(11)

The video distribution system according to (4), in which

in adjusting the parameter, the parameter adjustment unit performs one method alone or a combination of at least two methods of a first method of shifting a viewing position of the user from a center of a spherical surface on which a video is projected, a second method of changing an angle of the video projected on the spherical surface in a state where the viewing position of the user and the center of the spherical surface coincide, or a third method of shifting the center of the spherical surface from the viewing position of the user.

(12)

The video distribution system according to (11), in which

the parameter adjustment unit

shifts the viewing position of the user by bringing a position of a virtual camera corresponding to the viewing position of the user close to a projection surface of the spherical surface or away from the projection surface in a case where the first method is performed,

changes an angle of the video projected on the spherical surface by rotating the video projected on the spherical surface outward or inward in a case where the second method is performed, and

shifts the center of the spherical surface by moving the position of the center of the spherical surface outward or inward with respect to the position of the virtual camera in a case where the third method is performed.

(13)

The video distribution system according to any one of (1) to (12), in which

the first camera is installed at a position on a left side with respect to the subject when the subject is viewed from a front, and

the second camera is installed at a position on a right side with respect to the subject when the subject is viewed from the front.

(14)

The video distribution system according to (13), in which

a video representing the virtual space including the virtual subject is displayed by

projecting a first video corresponding to the first image captured by the first camera on a first spherical surface centered on a position of a first virtual camera corresponding to a left eye of the user in the virtual space, and

projecting a second video corresponding to the second image captured by the second camera on a second spherical surface centered on a position of a second virtual camera corresponding to a right eye of the user in the virtual space.

(15)

The video distribution system according to (14), in which

the first spherical surface and the second spherical surface include a spherical surface corresponding to an entire celestial sphere or a half celestial sphere.

(16)

The video distribution system according to (3), in which

the parameter adjustment unit adjusts the parameter in such a manner that the virtual subject corresponding to a state where the first distance and the second distance are different is displayed in a case where the first distance and the second distance coincide or are different from each other.

(17)

The video distribution system according to any one of (1) to (16), in which

when there is a change in the subject as an image-capturing target, the parameter adjustment unit dynamically adjusts the parameter according to an amount of the change.

(18)

The video distribution system according to any one of (1) to (17), in which

the display terminal includes a head mounted display.

(19)

A video distribution method including, by a video distribution system:

acquiring a first image and a second image of a subject captured by a first camera and a second camera;

adjusting a parameter that affects an appearance to a user regarding a virtual subject corresponding to the subject in a virtual space represented by the first image and the second image that have been acquired; and

displaying a video representing the virtual space including the virtual subject corresponding to the adjusted parameter on a display terminal.

(20)

A display terminal including:

a display control unit that displays, on a display terminal, a video representing a virtual space including a virtual subject whose parameter is adjusted, the parameter affecting an appearance to a user regarding the virtual subject corresponding to a subject in the virtual space represented by a first image and a second image of the subject captured by a first camera and a second camera.

### REFERENCE SIGNS LIST

1 Video distribution system
10 Workstation
11, 11-L, 11-R Camera
12 Video distribution server
20, 20-1 to 20-N Display terminal
100 Processing unit
101 Input unit
102 Output unit
103 Storage unit
104 Communication unit
111 Image acquisition unit
112 Image processing unit
113 Transmission control unit
120 Imaging unit
130 Inter-optical axis distance detection unit
200 Processing unit
201 Sensor unit
202 Storage unit
203 Display unit
204 Audio output unit
205 Input terminal
206 Output terminal
207 Communication unit
211 Image acquisition unit
212 Image processing unit
213 Display control unit
220 Reproduction unit
230 Interpupillary distance detection unit
300 Conversion processing unit
320 Parameter adjustment unit
1001 CPU

1. A video distribution system comprising:
an image acquisition unit that acquires a first image and a second image of a subject captured by a first camera and a second camera;
a parameter adjustment unit that adjusts a parameter that affects an appearance to a user regarding a virtual subject corresponding to the subject in a virtual space represented by the first image and the second image that have been acquired; and
a display control unit that displays a video representing the virtual space including the virtual subject corresponding to the adjusted parameter on a display terminal.

2. The video distribution system according to claim 1, wherein
the parameter includes a parameter related to at least one of a first distance between the first camera and the second camera, a second distance between pupils of the user, a distance to the virtual subject, or a size of the virtual subject.

3. The video distribution system according to claim 2, wherein
the parameter includes a parameter correlated with a relationship between the first distance and the second distance.

4. The video distribution system according to claim 3, wherein
in a case where the first distance and the second distance are different, the parameter adjustment unit adjusts the parameter in such a manner that the virtual subject corresponding to a state where the first distance and the second distance coincide is displayed.

5. The video distribution system according to claim 4, wherein
the parameter adjustment unit adjusts the parameter in such a manner that a viewing position of the user is shifted from a center of a spherical surface on which a video is projected.

6. The video distribution system according to claim 5, wherein
the parameter adjustment unit brings a position of a virtual camera corresponding to the viewing position of the user close to a projection surface of the spherical surface or away from the projection surface.

7. The video distribution system according to claim 4, wherein
the parameter adjustment unit adjusts the parameter in such a manner that, in a state where a viewing position of the user and a position of a center of a spherical surface on which a video is projected coincide, an angle of the video projected on the spherical surface changes.

8. The video distribution system according to claim 7, wherein
the parameter adjustment unit rotates the video projected on the spherical surface outward or inward.

9. The video distribution system according to claim 4, wherein
the parameter adjustment unit adjusts the parameter in such a manner that a center of a spherical surface on which a video is projected is shifted from a viewing position of the user.

10. The video distribution system according to claim 9, wherein
the parameter adjustment unit moves a position of the center of the spherical surface outward or inward with respect to a position of a virtual camera corresponding to the viewing position of the user.

11. The video distribution system according to claim 4, wherein
in adjusting the parameter, the parameter adjustment unit performs one method alone or a combination of at least two methods of a first method of shifting a viewing position of the user from a center of a spherical surface on which a video is projected, a second method of changing an angle of the video projected on the spherical surface in a state where the viewing position of the user and the center of the spherical surface coincide, or a third method of shifting the center of the spherical surface from the viewing position of the user.

12. The video distribution system according to claim 11, wherein
the parameter adjustment unit
shifts the viewing position of the user by bringing a position of a virtual camera corresponding to the viewing position of the user close to a projection surface of the spherical surface or away from the projection surface in a case where the first method is performed,
changes an angle of the video projected on the spherical surface by rotating the video projected on the spherical surface outward or inward in a case where the second method is performed, and
shifts the center of the spherical surface by moving the position of the center of the spherical surface outward or inward with respect to the position of the virtual camera in a case where the third method is performed.

13. The video distribution system according to claim 1, wherein
the first camera is installed at a position on a left side with respect to the subject when the subject is viewed from a front, and
the second camera is installed at a position on a right side with respect to the subject when the subject is viewed from the front.

14. The video distribution system according to claim 13, wherein
a video representing the virtual space including the virtual subject is displayed by
projecting a first video corresponding to the first image captured by the first camera on a first spherical surface centered on a position of a first virtual camera corresponding to a left eye of the user in the virtual space, and
projecting a second video corresponding to the second image captured by the second camera on a second spherical surface centered on a position of a second virtual camera corresponding to a right eye of the user in the virtual space.

15. The video distribution system according to claim 14, wherein
the first spherical surface and the second spherical surface include a spherical surface corresponding to an entire celestial sphere or a half celestial sphere.

16. The video distribution system according to claim 3, wherein
the parameter adjustment unit adjusts the parameter in such a manner that the virtual subject corresponding to a state where the first distance and the second distance are different is displayed in a case where the first distance and the second distance coincide or are different from each other.

17. The video distribution system according to claim 1, wherein
when there is a change in the subject as an image-capturing target, the parameter adjustment unit dynamically adjusts the parameter according to an amount of the change.

18. The video distribution system according to claim 1, wherein
the display terminal includes a head mounted display.

19. A video distribution method comprising, by a video distribution system:
acquiring a first image and a second image of a subject captured by a first camera and a second camera;
adjusting a parameter that affects an appearance to a user regarding a virtual subject corresponding to the subject in a virtual space represented by the first image and the second image that have been acquired; and
displaying a video representing the virtual space including the virtual subject corresponding to the adjusted parameter on a display terminal.

20. A display terminal comprising:
a display control unit that displays, on a display terminal, a video representing a virtual space including a virtual subject whose parameter is adjusted, the parameter affecting an appearance to a user regarding the virtual subject corresponding to a subject in the virtual space represented by a first image and a second image of the subject captured by a first camera and a second camera.
